(19) United States
(12) Patent Application Publication
(10) Pub. No.: US 2026/0169208 A1
(43) Pub. Date: Jun. 18, 2026

(54) OPTICAL ELEMENT AND OPTICAL INSTRUMENT

(71) Applicant: SEIKO EPSON CORPORATION, Tokyo (JP)

(72) Inventors: Koya SHIRATORI, MATSUMOTO-SHI (JP); Kunihiko YANO, SHIOJIRI-SHI (JP)

(21) Appl. No.: 19/416,802

(22) Filed: Dec. 11, 2025

(30) Foreign Application Priority Data
Dec. 13, 2024 (JP) 2024-218756

(51) Int. Cl. G02B 5/20; G03B 21/20

(52) U.S. Cl. CPC G02B 5/208; G03B 21/2013; G03B 21/2066; G03B 21/208

(57) ABSTRACT

An optical element according to an embodiment includes a substrate configured to transmit first light having a first wavelength band and second light having a second wavelength band different from the first wavelength band; and a first optical layer disposed in a first region in a plane parallel to a first surface of the substrate that is a surface on which the first light and the second light are incident. A refractive index and a thickness of the first optical layer are so set that the first light incident on the first region passes through the first region, that a phase difference between the first light having a centrobaric wavelength in the first wavelength band and passing through the first region and the first light having the centrobaric wavelength and passing through a second region other than the first region in the plane parallel to the first surface is greater than or equal to −90° but smaller than or equal to 90°, and that the second light incident on the first region is blocked.

The present application is based on, and claims priority from JP Application Serial Number 2024-218756, filed Dec. 13, 2024, the disclosure of which is hereby incorporated by reference herein in its entirety.

### BACKGROUND

### 1. Technical Field

The present disclosure relates to an optical element and an optical instrument.

### 2. Related Art

In an image display apparatus such as a projector, to control a visible image of a display target that is formed by visible light, the visible image is superimposed on an invisible image formed, for example, by infrared light on a display surface, and the relative arrangement of elements in the apparatus and conditions under which the apparatus forms image light and operations of the apparatus are adjusted in some cases based on information that can be acquired from the invisible image. In this case, for example, an optical element at which a predetermined pattern is formed is disposed in the optical path of the visible light and the infrared light near a light modulator that forms the image light. The visible light emitted from the optical element passes through the predetermined pattern but does not generate patterned light according to the predetermined pattern. On the other hand, the infrared light emitted from the optical element exits in a direction different from the direction in which the visible light exits due to the predetermined pattern, and generates patterned light. As a result, an invisible image according to the predetermined pattern is displayed on the display surface of the image display apparatus.

For example, JP-A-2019-174600 discloses a projector including the optical element described above, and an imaging element that captures an invisible image formed by infrared light reflected off a pointing element such as a hand that moves relative to a projection surface (display surface) and points an object on the projection surface. In the projector disclosed in JP-A-2019-174600, the position and movement of the pointing element are detected based on the acquired invisible image.

JP-A-2019-174600 is an example of the related art.

The optical element described above, for example, is conceivably an element including a base that transmits visible light and infrared light, and a predetermined pattern that is provided at a surface of the base, transmits the visible light, and reflects the infrared light. However, when the optical element described above is disposed in the projector disclosed in JP-A-2019-174600 described above, visible light is scattered or diffracted at the edge of a layer or a film that constitutes the pattern, so that there is a concern that illuminance unevenness of image light and noise in the invisible image occur due to the scattered light or diffracted light. That is, the optical element used to generate patterned light having a first wavelength requires a countermeasure for preventing patterned light having a second wavelength resulting from the scattered light, the diffracted light, or the like according to the predetermined pattern from being generated when light having the second wavelength that does not originally generate patterned light is incident on the optical element.

### SUMMARY

An optical element according to an aspect of the present disclosure includes a substrate configured to transmit first light having a first wavelength band and second light having a second wavelength band different from the first wavelength band; and a first optical layer disposed in a first region in a plane parallel to a first surface of the substrate that is a surface on which the first light and the second light are incident. A refractive index and a thickness of the first optical layer are so set that the first light incident on the first region passes through the first region, that a phase difference between the first light having a centrobaric wavelength in the first wavelength band and passing through the first region and the first light having the centrobaric wavelength and passing through a second region other than the first region in the plane parallel to the first surface is greater than or equal to −90° but smaller than or equal to 90°, and that the second light incident on the first region is blocked.

### BRIEF DESCRIPTION OF THE DRAWINGS

FIG. 1 is a schematic view of a projector according to a first embodiment.

FIG. 2 is a front view of an optical element of the projector shown in FIG. 1.

FIG. 3 is a cross-sectional view of an optical element in FIG. 2 taken along the line III-III shown in FIG. 2.

FIG. 4 is a diagrammatic view of part of green light emitted from the optical element in FIG. 2.

FIG. 5 is a diagrammatic view of part of infrared light emitted from the optical element in FIG. 2.

FIG. 6 shows a graph representing the dependence of the phase difference between light passing through a first region of the optical element and light passing through a second region of the optical element in FIG. 2 on wavelength.

FIG. 7 is a diagrammatic view illustrating the interaction between light emitted from a point light source and light emitted from another point light source.

FIG. 8 shows a graph representing the dependence of the amplitude of the light as a result of superposition of green light passing through the first region of the optical element and green light passing through the second region of the optical element in FIG. 2 on the phase difference.

FIG. 9 shows graphs representing the wavelength dependence of the reflectance and transmittance of the first region of the optical element in FIG. 2, on which the light is incident.

FIG. 10 shows graphs representing the wavelength dependence of the reflectance and transmittance of the second region of the optical element in FIG. 2, on which the light is incident.

FIG. 11 shows graphs representing the wavelength dependence of the phase difference between the green light passing through the first region of the optical element and the green light passing through the second region of the optical element in FIG. 2.

FIG. 12 is a cross-sectional view of an optical element of related art.

FIG. 13 is a diagrammatic view of part of the green light emitted from the optical element of related art.

FIG. 14 shows graphs representing the wavelength dependence of the reflectance and transmittance of the second region of the optical element of related art, on which the light is incident.

FIG. 15 shows graphs representing the wavelength dependence of the phase difference between the green light passing through the first region of the optical element of related art and the green light passing through the second region of the optical element.

FIG. 16 is a cross-sectional view of an optical element according to a second embodiment, and corresponds to a cross-sectional view taken along the line III-III shown in FIG. 2.

FIG. 17 shows graphs representing the wavelength dependence of the reflectance and transmittance of the first region of the optical element according to the second embodiment, on which the light is incident.

FIG. 18 shows graphs representing the wavelength dependence of the phase difference between the green light passing through the first region of the optical element according to the second embodiment and the green light passing through the second region of the optical element.

FIG. 19 is a cross-sectional view of an optical element according to a third embodiment, and corresponds to a cross-sectional view taken along the line III-III shown in FIG. 2.

FIG. 20 shows graphs representing the wavelength dependence of the reflectance and transmittance of the first region of the optical element according to the third embodiment, on which the light is incident.

FIG. 21 shows graphs representing the wavelength dependence of the phase difference between the green light passing through the first region of the optical element according to the third embodiment and the green light passing through the second region of the optical element.

FIG. 22 shows graphs representing the wavelength dependence of the phase difference between the green light passing through the first region of a variation of the optical element and the green light passing through the second region of the optical element in FIG. 2.

### DESCRIPTION OF EMBODIMENTS

Embodiments of the present disclosure will be described below with reference to the drawings. In the drawings, elements are each drawn at a dimensional scale changed from the actual value in some cases for clarity of the element.

### First Embodiment

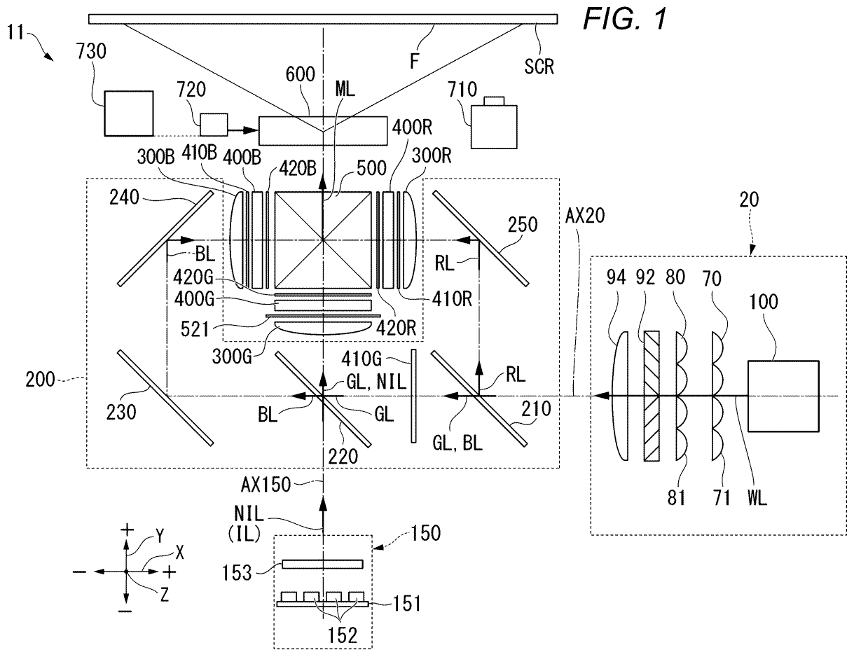

A first embodiment of the present disclosure will first be described with reference to FIGS. 1 to 15. FIG. 1 is a schematic view showing the configuration of a projector 11 according to the first embodiment of the present disclosure. The projector 11 is an optical instrument and an image display apparatus including three liquid crystal panels as light modulators, and is what is called a three-plate projector. The projector 11 corresponds to an optical instrument to be described later and an optical instrument described in the claims.

### Projector

The projector 11 includes an illuminator 20, a light source apparatus 150, a color separation system 200, field lenses 300R, 300G, and 300B, light-incident-side polarizers 410R, 410G, and 410B, light modulators 400R, 400G, and 400B, light-exiting-side polarizers 420R, 420G, and 420B, an optical element 521, a cross dichroic prism 500, a projection system 600, an imaging apparatus 710, a mechanism 720, and a movement controller 730, as shown in FIG. 1.

The illuminator 20 includes a light source apparatus 100, a first lens array 70, a second lens array 80, a polarization converter 92, and a superimposing lens 94. The illuminator 20 emits white light WL.

The light source apparatus 100 emits the white light WL toward a −X side along an X-axis. In the following description, an axis parallel to the optical axis of the white light WL emitted from the light source apparatus 100 is defined as the X-axis, one side of the X-axis is defined as the −X side, and the other side of the X-axis is defined as a +X side. An axis perpendicular to the X-axis is defined as a Y-axis, one side of the Y-axis is defined as a −Y side, and the other side of the Y-axis is defined as a +Y side. An axis perpendicular to a plane containing the X-axis and the Y-axis is defined as a Z-axis, one side of the Z-axis is defined as a −Z side, and the other side of the Z-axis is defined as a +Z side. Note that viewing along the Z-axis means a plan view.

The detailed configuration of the light source apparatus 100 is not limited to a specific configuration as long as the light source apparatus 100 can emit the white light WL. The light source apparatus 100 may be configured, for example, with a white light emitting diode (LED) in which a red LED, a green LED, and a blue LED are mounted on a common chip, or may include an LED or a laser diode (LD) that emits blue light and a phosphor that is excited by part of the blue light emitted from the LED or the LD to emit yellow light as fluorescence.

The white light WL emitted from the light source apparatus 100 is parallelized along the X-axis and enters the first lens array 70 from the +X side. The first lens array 70 is disposed closer to the −X side than the light source apparatus 100. The first lens array 70 includes multiple lenslets 71, which divide the white light WL emitted from the light source apparatus 100 into multiple sub-luminous fluxes in a plane containing the Y-axis and Z-axis. The multiple lenslets 71 are arranged in a matrix in the plane containing the Y-axis and the Z-axis perpendicular to an optical axis AX20 of the white light WL in the illuminator 20. The lenslets 71 are each, for example, a plano-convex lens having a light incident surface convex toward the +X side and a planar light exiting surface parallel to the plane containing the Y-axis and the Z-axis.

The second lens array 80 is disposed closer to the X side than the first lens array 70, and is disposed in a region where the second lens array 80 substantially overlaps with the first lens array 70 in a plane containing the Y-axis and the Z-axis. The second lens array 80 includes multiple lenslets 81 corresponding to the multiple lenslets 71 of the first lens array 70. The multiple lenslets 81 are arranged in a matrix in the plane containing the Y-axis and the Z-axis. The second lens array 80 along with the superimposing lens 94 forms images formed by the lenslets 71 of the first lens array 70 in the vicinity of an image formation region of each of the light modulators 400R, 400G, and 400B. The lenslets 81 are each, for example, a plano-convex lens having a light incident surface convex toward the +X side and a planar light exiting surface parallel to the plane containing the Y-axis and the Z-axis.

The polarization converter 92 is disposed closer to the −X side than the second lens array 80, and is disposed in a region where the polarization converter 92 substantially overlaps with the second lens array 80 in a plane containing the Y-axis and the Z-axis. The polarization converter 92 includes polarization separating layers, reflection layers, and phase retarders, none of which is shown. The polarization converter 92 converts the sub-luminous fluxes emitted from the second lens array 80 toward the −X side along the X-axis into linearly polarized light. The polarization converter 92 is formed in the shape of a plate as a whole. The plate surfaces of the polarization converter 92 are disposed in parallel to a plane containing the Y-axis and the Z-axis, that is, a plane perpendicular to the optical axis AX20.

The polarization separating layers of the polarization converter 92 transmit one linearly polarized component out of polarized components contained in the sub-luminous fluxes emitted from the second lens array 80, and reflect the other linearly polarized component in a direction perpendicular to the optical axis AX20. The reflection layers of the polarization converter 92 reflect the t other linear polarized component reflected off the polarization separating layers in the direction parallel to the optical axis AX20 along the X-axis. The phase retarders of the polarization converter 92 convert the other linearly polarized component reflected off the reflection layers into the one linearly polarized component.

The superimposing lens 94 is disposed closer to the −X side than the polarization converter 92, and is disposed in a region where the superimposing lens 94 substantially overlaps with the second lens array 80 in a plane containing the Y-axis and the Z-axis. The center of the superimposing lens 94 is disposed on the optical axis AX20. The superimposing lens 94 is, for example, a plano-convex lens having a planar light incident surface parallel to the plane containing the Y-axis and the Z-axis and a light exiting surface convex toward the −X side.

The superimposing lens 94 collects the sub-luminous fluxes emitted from the polarization converter 92 toward the −X side along the X-axis and superimposes the collected sub-luminous fluxes on one another in the vicinity of the image formation region of each of the light modulators 400R, 400G, and 400B. The first lens array 70, the second lens array 80, and the superimposing lens 94 constitute an optical integration system. The optical integration system homogenizes, in the image formation region of each of the light modulators 400R, 400G, and 400B, the optical intensity distribution of the white light WL to be emitted from the Illuminator 20 in a plane containing the Y-axis and the Z-axis.

The color separation system 200 includes dichroic mirrors 210 and 220 and reflection mirrors 230, 240, and 250. The color separation system 200 separates the white light WL emitted from the illuminator 20 toward the −X side along the X-axis into red light RL, green light GL, and blue light BL, which are visible light, and guides the red light RL, the green light GL, and the blue light BL to the light modulators 400R, 400G, and 400B, respectively. Infrared light IL is incident from the light source apparatus 150 on the dichroic mirror 220.

The dichroic mirror 210 is disposed closer to the −X side than the superimposing lens 94 of the illuminator 20. The dichroic mirror 210 transmits the green light GL and the blue light BL toward the −X side along the X-axis and reflects the red light RL toward the +Y side along the Y-axis out of the white light WL incident from the +X side along the X-axis.

The dichroic mirror 220 is disposed closer to the −X side than the dichroic mirror 210 and is disposed in a region where the dichroic mirror 220 substantially overlaps with the dichroic mirror 210 in a plane containing the Y-axis and the Z-axis. The dichroic mirror 220 transmits the blue light BL toward the −X side along the X-axis and reflects the green light GL toward the +Y side along the Y-axis out of the green light GL and the blue light BL incident from the +X side along the X-axis. The dichroic mirror 220 transmits the infrared light IL incident from the −Y side along the Y-axis.

The light-incident-side polarizer 410G is disposed in the optical path of the green light GL and the blue light BL between the dichroic mirrors 210 and 220 at a position off the optical path of the infrared light IL. The light-incident-side polarizer 410G is disposed in a region where the light-incident-side polarizer 410G substantially overlaps with the dichroic mirrors 210 and 220 in a plane containing the Y-axis and the Z-axis. The light-incident-side polarizer 410G transmits S-polarized light of the green light GL incident from the +X side along the X-axis toward the −X side along the X-axis, and reflects or absorbs P-polarized light of the green light GL. The light-incident-side polarizer 410G transmits the blue light BL incident from the +X side along the X-axis. The light-incident-side polarizer 410G is, for example, an inorganic polarizer.

The reflection mirror 230 is disposed closer to the −X side than the dichroic mirror 220 and is disposed in a region where the reflection mirror 230 substantially overlaps with the dichroic mirror 220 in a plane containing the Y-axis and the Z-axis. The reflection mirror 230 reflects the blue light BL incident from the +X side along the X-axis toward the +Y side along the Y-axis. The reflection mirror 240 is disposed closer to the +Y side than the reflection mirror 230 and is disposed in a region where the reflection mirror 240 substantially overlaps with the reflection mirror 230 in a plane containing the X-axis and the Z-axis. The reflection mirror 240 reflects the blue light BL incident from the −Y side along the Y-axis toward the +X side along the X-axis.

The reflection mirror 250 is disposed closer to the +Y side than the dichroic mirror 210, is disposed in a region where the reflection mirror 250 substantially overlaps with the dichroic mirror 210 in a plane containing the X-axis and the Z-axis, and is disposed in a region where the reflection mirror 250 substantially overlaps with the reflection mirror 240 in a plane containing the Y-axis and the Z-axis. The reflection mirror 250 reflects the red light RL incident from the −Y side along the Y-axis toward the −X side along the X-axis.

The cross dichroic prism 500 as a light combiner is disposed in a region where the optical path of the red light RL reflected off the reflection mirror 250 and emitted toward the −X side along the X-axis, the optical path of the green light GL reflected off the dichroic mirror 220 and emitted toward the +Y side along the Y-axis, and the optical path of the blue light BL reflected off the reflection mirror 240 and emitted toward the +X side along the X-axis overlap with each other.

The length of the optical path of the blue light BL from the dichroic mirror 210 to the cross dichroic prism 500 is longer than the lengths of the optical paths of the red light RL and the green light GL from the dichroic mirror 210 to the cross dichroic prism 500. A relay lens that is not shown may be disposed in the optical path of the blue light BL between the dichroic mirror 220 and the reflection mirror 230, and another relay lens that is not shown may be disposed in the optical path of the blue light BL between the reflection mirrors 230 and 240. The thus disposed relay lenses reduce the loss of the blue light BL traveling along an optical path length longer than those of the red light RL and the green light GL as described above.

The field lens 300R, the light-incident-side polarizer 410R, the light modulator 400R, and the light-exiting-side polarizer 420R are sequentially arranged from the +X side toward the −X side along the X-axis in the optical path of the red light RL between the reflection mirror 250 and the cross dichroic prism 500. The red light RL reflected off the reflection mirror 250 passes through the field lens 300R and enters the light-incident-side polarizer 410R. The light-incident-side polarizer 410R is disposed in the optical path of the red light RL between the field lens 300R and the light modulator 400R. The light-incident-side polarizer 410R transmits the S-polarized light of the red light RL incident from the +X side along the X-axis toward the −X side, and reflects or absorbs the P-polarized light of the red light RL.

The S-polarized red light RL emitted from the light-incident-side polarizer 410R is incident on the image formation region of the light modulator 400R and is converted by the light modulator 400R into red image light. The light modulator 400R modulates the red light RL incident from the +X side along the X-axis in accordance with image information input from an image input apparatus, a controller, or any other apparatus that is not shown to form the red image light, and emits the red image light toward the −X side along the X-axis. The light modulators 400R, 400G, and 400B are each configured, for example, with a liquid crystal panel. The operation mode of the liquid crystal panels may be any one of a TN mode, a VA mode, a lateral electric field mode, and the like, and is not limited to a specific mode.

The red image light emitted from the light modulator 400R enters the light-exiting-side polarizer 420R.

The light-exiting-side polarizer 420R is disposed in the optical path of the red image light between the light modulator 400R and the cross dichroic prism 500. The light-exiting-side polarizer 420R transmits the P-polarized light of the red image light incident from the +X side along the X-axis toward the −X side, and reflects or absorbs the S-polarized light of the red image light.

The field lens 300G, the optical element 521, the light modulator 400G, and the light-exiting-side polarizer 420G are sequentially arranged from the −Y side toward the +Y side along the Y-axis in the optical path of the green light GL between the dichroic mirror 220 and the cross dichroic prism 500. The green light GL reflected off the dichroic mirror 220 passes through the field lens 300G and the optical element 521, and enters the light modulator 400G. The configuration of the optical element 521 and the behavior of the green light GL and the infrared light IL passing through the optical element 521 will be described later.

The S-polarized green light GL emitted from the field lens 300G is incident on the image formation region of the light modulator 400G and is converted by the light modulator 400G into green image light. The light modulator 400G modulates the green light GL incident from the −Y side in accordance with image information input from the image input apparatus, the controller, or the other apparatus, which is not shown, to form the green image light, and emits the green image light toward the +Y side along the Y-axis.

The green image light emitted from the light modulator 400G enters the light-exiting-side polarizer 420G.

The light-exiting-side polarizer 420G is disposed in the optical path of the green image light between the light modulator 400G and the cross dichroic prism 500. The light-exiting-side polarizer 420G transmits the P-polarized light of the incident green image light toward the +Y side along the Y-axis, and reflects or absorbs the S-polarized light of the green image light. The light-exiting-side polarizer 420G is, for example, an organic polarizer.

The field lens 300B, the light-incident-side polarizer 410B, the light modulator 400B, and the light-exiting-side polarizer 420B are sequentially arranged from the −X side toward the +X side along the X-axis in the optical path of the blue light BL between the reflection mirror 240 and the cross dichroic prism 500. The blue light BL reflected off the reflection mirror 240 passes through the field lens 300B and enters the light-incident-side polarizer 410B. The light-incident-side polarizer 410B is disposed in the optical path of the blue light BL between the field lens 300B and the light modulator 400B. The light-incident-side polarizer 410B transmits the S-polarized light of the blue light BL incident from the −X side along the X-axis toward the +X side, and reflects or absorbs the P-polarized light of the blue light BL.

The S-polarized blue light BL emitted from the light-incident-side polarizer 410B is incident on the image formation region of the light modulator 400B and is converted by the light modulator 400B into blue image light. The light modulator 400B modulates the blue light BL incident from the −X side along the X-axis in accordance with image information input from the image input apparatus, the controller, or the other apparatus, which is not shown, to form the blue image light, and emits the blue image light toward the +X side along the X-axis.

The blue image light emitted from the light modulator 400B enters the light-exiting-side polarizer 420B.

The light-exiting-side polarizer 420B is disposed in the optical path of the blue image light between the light modulator 400B and the cross dichroic prism 500. The light-exiting-side polarizer 420B transmits the P-polarized light of the blue image light incident from the −X side along the X-axis toward the +X side, and reflects or absorbs the S-polarized light of the blue image light.

The light source apparatus 150 includes a substrate 151, multiple light emitters 152, and a homogenizer 153. The substrate 151 and the homogenizer 153 are disposed in a region where the substrate 151 and the homogenizer 153 substantially overlap with the dichroic mirror 220 of the color separation system 200 in a plane containing the X-axis and the Z-axis. The substrate 151 is, for example, a plate-shaped member made of metal. The substrate 151 has plate surfaces parallel to the plane containing the X-axis and the Z-axis. The multiple light emitters 152 are disposed at the +Y-side plate surface of the substrate 151, which is the surface facing the dichroic mirror 220.

The light emitters 152 emit the infrared light IL toward the +Y side along the Y-axis. The wavelength of the infrared light IL is, for example, longer than or equal to 930 nm but shorter than or equal to 950 nm, and belongs to the near-infrared wavelength band. Note that the light source apparatus 150 may instead include only one light emitter 152. The light emitters 152 may each, for example, be an LED that emits the infrared light IL.

The homogenizer 153 is disposed closer to the +Y side than the multiple light emitters 152, disposed in the optical path of the infrared light IL emitted from the multiple light emitters 152, and disposed between the multiple light emitters 152 and the dichroic mirror 220 of the color separation system 200. The homogenizer 153 homogenizes the optical intensity distribution of the luminous flux of the infrared light IL emitted from the multiple light emitters 152 in a plane perpendicular to an optical axis AX150 of the luminous flux of the infrared light IL, that is, a plane containing the X-axis and the Z-axis. The homogenizer 153 emits the infrared light IL having a uniform optical intensity distribution in the plane containing the X-axis and the Z-axis toward the +Y side along the Y-axis, that is, toward the dichroic mirror 220.

The homogenizer 153 is, for example, a light collecting lens including at least one convex lens, a holographic optical element (HOE) formed by a computer-generated hologram (CGH), or a diffractive optical element (DOE).

The infrared light IL emitted from the homogenizer 153 of the light source apparatus 150 toward the +Y side along the Y-axis passes through the dichroic mirror 220 of the color separation system 200, is further emitted toward the +Y side, and sequentially passes through the field lens 300G and the optical element 521.

The infrared light IL passing through the optical element 521 forms patterned light having a predetermined pattern in a plane containing the X-axis and the Z-axis. The patterned light formed by the infrared light IL is incident on the image formation region of the light modulator 400G, but is not converted into image light by the light modulator 400G, and is emitted from the light modulator 400G toward the +Y side along the Y-axis. The light-exiting-side polarizer 420G transmits the P-polarized light of the incident infrared light IL toward the +Y side along the Y-axis, and reflects or absorbs the S-polarized light of the infrared light IL.

The cross dichroic prism 500 reflects the red image light emitted from the light-exiting-side polarizer 420R and incident from the +X side along the X-axis, and emits the red image light toward the +Y side along the Y-axis. The cross dichroic prism 500 transmits the green image light and the patterned infrared light IL emitted from the light-exiting-side polarizer 420G and incident from the −Y side along the Y-axis, emits the green image light and the patterned infrared light IL toward the +Y side along the Y-axis, and superimposes the green image light and the patterned infrared light IL on the red image light. The cross dichroic prism 500 reflects the blue image light emitted from the light-exiting-side polarizer 420B and incident from the −X side along the X-axis, emits the blue image light toward the +Y side along the Y-axis, and superimposes the blue image light on the red image light and the green image light.

The cross dichroic prism 500 is configured, for example, with four right-angle prisms in a way that the apex angles thereof coincide with a common center position in a plan view, and is therefore formed in a substantially cubic shape as a whole. In the cross dichroic prism 500, dichroic mirrors configured, for example, with dielectric multilayer films that are not shown are formed at the interfaces where the right-angle prisms are bonded to each other. The dielectric multilayer films, which are not shown, reflect the red light RL or the blue light BL incident along the X-axis and emits the red light RL or the blue light BL toward the +Y side along the Y-axis, and transmit the green light GL incident from the −Y side along the Y-axis and emits the green light GL toward the +Y side.

The cross dichroic prism 500 combines the image light emitted from the light modulator 400R, the image light emitted from the light modulator 400G, and the image light emitted from the light modulator 400B with one another to generate color image light ML, and emits the image light ML and the patterned infrared light IL into a common optical path, as described above.

The projection system 600 is disposed closer to the +Y side than the cross dichroic prism 500 and is disposed in a region where the projection system 600 substantially overlaps with the cross dichroic prism 500 in a plane containing the X-axis and the Z-axis. The projection system 600 enlarges the image light ML and the infrared light IL emitted from the cross dichroic prism 500, and projects the enlarged image light ML and infrared light IL onto a screen SCR. The projection system 600 are configured with one or more optical lenses. Examples of the optical lenses include a plano-convex lens, a biconvex lens, a biconcave lens, a meniscus lens, an aspherical lens, a freeform surface lens, and a cemented lens.

A projection surface of the screen SCR is disposed in parallel to a plane containing the X-axis and the Z-axis, and is disposed to face a light exiting surface of the projection system 600.

The imaging apparatus 710 is disposed closer to the −Y side than the screen SCR, and is disposed in the projector 11 at any place where the imaging apparatus 710 does not block the light emitted from the projection system 600. A light receiving surface of the imaging apparatus 710 faces the projection surface of the screen SCR. The imaging apparatus 710 captures an image of the pattern of the infrared light IL projected by the projection system 600. The imaging apparatus 710 is, for example, an imaging camera having sensitivity to the infrared light IL. The imaging apparatus 710 is, for example, a near-infrared camera device.

The infrared light IL preferably near-infrared light NIL having a wavelength band longer than or equal to 930 nm but shorter than or equal to 950 nm. Using the near-infrared light NIL having the wavelength band longer than or equal to 930 nm but shorter than or equal to 950 nm, which is low-energy sunlight, as the infrared light IL can suppress a decrease in the contrast of the pattern of the infrared light IL due to the sunlight when the screen SCR is irradiated with the infrared light IL. As a result, the imaging apparatus 710 can capture an image of the pattern of the infrared light IL with favorable accuracy.

The movement mechanism 720 is disposed in the projector 11 at an appropriate place around the projection system 600, and is disposed at a place where the movement mechanism 720 does not block the light emitted from the projection system 600. The movement mechanism 720 receives an electric signal from the controller 730, and adjusts the position of the projection system 600 as appropriate to adjust the position of a projection image and the position of the pattern of the infrared light IL on the screen SCR.

The controller 730 controls the movement mechanism 720 and the light modulators 400R, 400G, and 400B in accordance with the pattern of the infrared light IL imaged by the imaging apparatus 710. The controller 730 changes, for example, at least one of a region where and conditions under which the red image light is formed in an image display region of the light modulator 400R, a region where and conditions under which the green image light is formed in an image display region of the light modulator 400G, and a region where and conditions under which the blue image light is formed in an image display region of the light modulator 400B in accordance with the pattern of the infrared light IL imaged by the imaging apparatus 710.

The controller 730 is configured, for example, with a computer or an integrated circuit in which processes carried out by drivers that t drive the imaging apparatus 710, the movement mechanism 720, the light source apparatus 150, and the light modulators 400R, 400G, and 400B are recorded in the form of a program. The controller 730 is, for example, a processor. The controller 730 is electrically coupled to drive circuits that drive the imaging apparatus 710, the movement mechanism 720, the light source apparatus 150, and the light modulators 400R, 400G, and 400B in a wired or wireless environment that is not shown.

### Optical Element

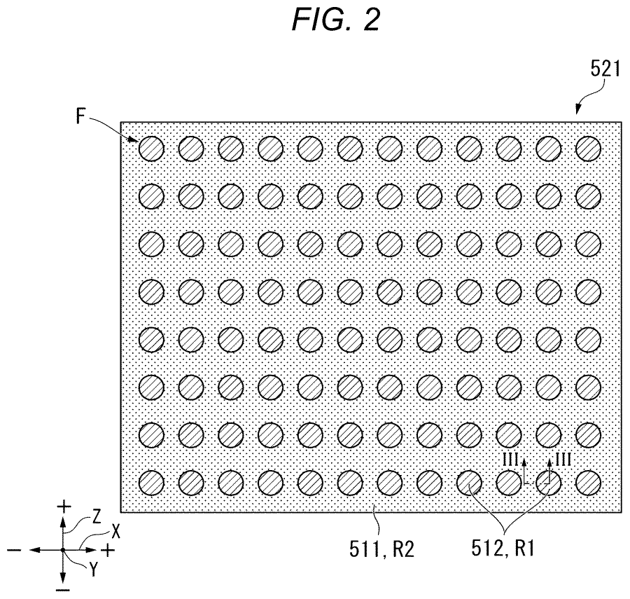

FIG. 2 is a front view of the optical element 521 viewed in the direction in which the green light GL and the infrared light IL are incident on the optical element 521, that is, from the −Y side along the Y-axis. The optical element 521 includes a transmissive portion 511 and blocking portions 512, as shown in FIG. 2. The transmissive portion 511 transmits and emits both the green light GL and the infrared light IL toward the +Y side along the Y-axis. The blocking portions 512 transmit and emit the green light GL toward the +Y side along the Y-axis, and reflect or absorb the infrared light IL to block the infrared light IL.

The blocking portions 512 are disposed in the form of a predetermined pattern F. The predetermined pattern F is, for example, a multi-dot pattern. When viewed along the Y-axis, each of the dots that constitute the blocking portions 512 has, for example, a circular shape. The blocking portions 512 are configured, for example, with dot-shaped regions two-dimensionally arranged at appropriate intervals along the X-axis and the Z-axis in the region of the transmissive portion 511.

The predetermined pattern F is not limited to the multi-dot pattern described above, and may, for example, be a multi-cross pattern, or a pattern having one or more marks, characters, or other objects, and only needs to be a pattern an image of which can be captured at least by the imaging apparatus 710.

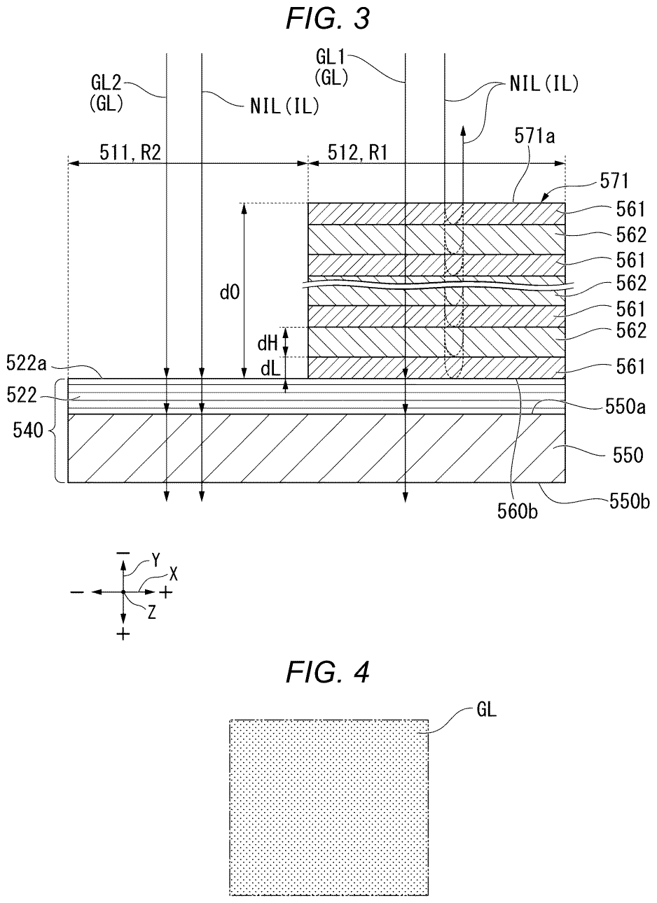

FIG. 3 is a cross-sectional view of key portions of the optical element 521 taken along the line III-III shown in FIG. 2. The optical element 521 includes a substrate 550, a multilayer film 522, and a multilayer film 571, as shown in FIG. 3. The substrate 550 and the multilayer film 522 are optical elements common to a first region R1 and a second region R2, and function as a substrate 540.

The substrate 550 has two plate surfaces 550a and 550b. The plate surface 550a is the −Y-side surface parallel to a plane containing the X-axis and the Z-axis. The plate surface 550b is the +Y-side surface parallel to the plane containing the X-axis and the Z-axis. The plate surface 550b corresponds to a first surface described later and a first surface described in the claims. The substrate 550 transmits the green light GL and the infrared light IL incident from the −Y side along the Y-axis, and emits the green light GL and the infrared light IL toward the +Y side.

In the optical element 521, the green light GL corresponds to first light described later and, corresponds to the first light described in the claims. The wavelength band of the green light GL corresponds to a first wavelength band described later, corresponds to the first wavelength band described in the claims, and is, for example, longer than or equal to 500 nm but shorter than or equal to 600 nm. In the optical element 521, the infrared light IL, that is, the near-infrared light NIL corresponds to second light described later, and corresponds to the second light described in the claims. The wavelength band of the infrared light IL, that is, the near-infrared light NIL corresponds to a second wavelength band described later, corresponds to the second wavelength band described in the claims, and is, for example, longer than or equal to 900 nm but shorter than or equal to 1000 nm.

The substrate 550 is a light-transmissive substrate that transmits the green light GL having the first wavelength band described above and the infrared light IL having the second wavelength band described above, and is a substrate made, for example, of silicon dioxide (SiO₂).

The multilayer film 522 is formed at the plate surface 550a of the substrate 550, and is layered on the −Y side of the substrate 550. The multilayer film 522 corresponds to a second optical layer described later, and corresponds to the second optical layer described in the claims. A −Y-side surface 522a of the multilayer film 522 corresponds to a third surface described later, and corresponds to the third surface described in the claims.

The multilayer film 522 transmits substantially all the green light GL and the infrared light IL incident from the −Y side along the Y-axis, and causes the green light GL and the infrared light IL to enter the substrate 550 from the −Y side. The multilayer film 522 acts as an antireflection film for the substrate 550. The multilayer film 522 is, for example, a dielectric multilayer film configured with high refractive index layers that are not shown and have a relatively high refractive index, and low refractive index layers that are not shown and have a refractive index lower than that of the high refractive index layers.

Note that a multilayer film that is not shown but is configured with high refractive index layers and low refractive index layers may be formed at the plate surface 550b of the substrate 550, as the multilayer film 522. The multilayer film acts as an antireflection film, as the multilayer film 522.

The substrate 550 is partitioned into a first region R1 acting as the blocking portions 512 and a second region R2 acting as the transmissive portion 511 when viewed from the −Y side along the Y-axis. The surface 522a of the multilayer film 522 at the substrate 550 is parallel to a plane containing the X-axis and the Z-axis and is the −Y-side surface.

The multilayer film 571 is formed at the surface 522a of the multilayer film 522 in the first region R1 and is layered on the −Y side of the substrate 550. The multilayer film 571 corresponds to a first optical layer described later, and corresponds to the first optical layer described in the claims. The multilayer film 571 transmits the green light GL incident from the −Y side along the Y-axis and emits the green light GL toward the +Y side, and reflects the infrared light IL incident from the −Y side along the Y-axis and emits the infrared light IL toward the −Y side.

The multilayer film 571 is a dielectric multilayer film configured with low refractive index layers 561 and high refractive index layers 562. Specifically, the multilayer film 571 is a film in which the low refractive index layers 561 and the high refractive index layers 562 are alternately layered on each other along the Y-axis. For example, a low refractive index layer 561 is disposed on the side closest to the +Y side of the multilayer film 571, and another low refractive index layer 561 is disposed on the side closest to the −Y side of the multilayer film 571.

The material of the low refractive index layers 561 is selected in accordance with an appropriately set refractive index, as will be described later, and is preferably any of an oxide, a nitride, and a fluoride, for example, SiO₂.

The high refractive index layers 562 have a refractive index higher than that of the low refractive index layers 561 in the first wavelength band of the green light GL and the second wavelength band of the infrared light IL. The material of the high refractive index layers 562 is selected in accordance with an appropriately set refractive index, as will be described later, and is preferably any of an oxide, a nitride, and a fluoride, for example, niobium pentoxide (Nb₂O₅).

A thickness dL of each of the low refractive index layers 561, that is, the size of the low refractive index layer 561 along the Y-axis is appropriately set in accordance with a refractive index nL of the low refractive index layers 561 in the first wavelength band of the green light GL and the second wavelength band of the infrared light IL. Similarly, a thickness dH of each of the high refractive index layers 562, that is, the size of the high refractive index layer 562 along the Y-axis is appropriately set in accordance with a refractive index nH of the high refractive index layers 562 in the first wavelength band of the green light GL and the second wavelength band of the infrared light IL.

The infrared light IL that enters the multilayer film 571 from the −Y side along the Y-axis undergoes multiple reflection at the interfaces between the low refractive index layers 561 and the high refractive index layers 562, which are alternately layered on each other, and as a result, the infrared light IL is reflected toward the −Y side of the multilayer film 571 and is not emitted toward the +Y side of the multilayer film 571.

FIG. 4 is a diagrammatic view of a portion of an illuminance pattern, in a plane containing the X-axis and the Z-axis, of the green light GL emitted from the optical element 521 toward the +Y side along the Y-axis. The green light GL that enters the optical element 521 passes through the transmissive portion 511 and the second region R2, and also passes through the blocking portions 512 and the first regions R1. The illuminance, in the plane containing the X-axis and the Z-axis, of the green light GL emitted from the optical element 521 toward the +Y side is substantially uniform, and the pattern F is not generated in the green light GL emitted from the optical element 521 toward the +Y side, as shown in FIG. 4.

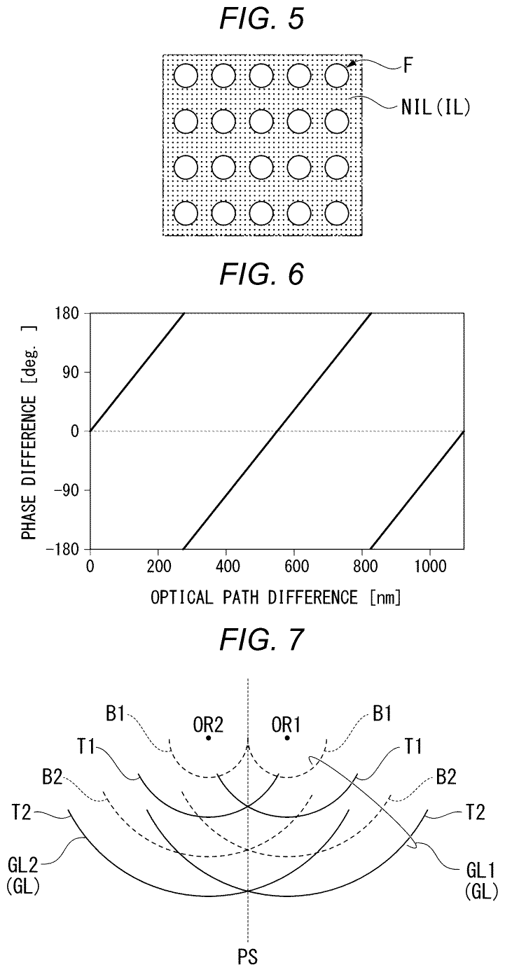

FIG. 5 is a diagrammatic view of a portion of the illuminance pattern, in the plane containing the X-axis and the Z-axis, of the infrared light IL emitted from the optical element 521 toward the +Y side along the Y-axis. The infrared light IL that enters the optical element 521 passes through the transmissive portion 511 and the second region R2, but is reflected off and blocked by the blocking portions 512 and the first regions R1. The illuminance, at the blocking portions 512 in the plane containing the X-axis and the Z-axis, of the infrared light IL emitted from the optical element 521 toward the +Y side is lower than the illuminance at the transmissive portion 511, and the pattern F is formed in the infrared light IL emitted from the optical element 521 toward the +Y side, as shown in FIG. 5.

The behaviors of the green light GL and the infrared light IL in the optical element 521 will next be described. Referring again to FIG. 3, it is assumed that the thickness of the multilayer film 571, that is, the size of the entire multilayer film 571 along the Y-axis is d0. In the second region R2, an optical path length OP1 of the light passing along the Y-axis through an air region which has the thickness d0 and in which the multilayer film 571 is not formed is n0×d0, which is comparable to d0. n0 represents the refractive index of the atmosphere. An optical path length OP2 of the light passing along the Y-axis through the multilayer film 571 in the first region R1 is expressed by Expression (1) below.

$$OP 2 = {\sum }_{i = 1}^{k} {n}_{i} \times {d}_{i} \qquad ( 1 )$$

In Expression (1), k is the total number of the low refractive index layers 561 and the high refractive index layers 562, nᵢ is the refractive index of the i-th low refractive index layer 561 or high refractive index layer 562 counted from the +Y side in the multilayer film 571 at a reference wavelength of the light passing through the layer, and dᵢ is the thickness of the i-th low refractive index layer 561 or high refractive index layer 562 counted from the +Y side in the multilayer film 571. When the light has a predetermined wavelength band, the reference wavelength of the light means the center wavelength, the peak wavelength, or the centrobaric wavelength of the light, and corresponds to a centrobaric wavelength described later and the centroid wavelength described in the claims. For example, when i=1, nᵢ=nL and dᵢ=dL.

An optical path length difference ΔOP between the optical path length OP1 and the optical path length OP2 is expressed by Expression (2) below. The difference in optical elements in the optical path between green light GL1 passing through the first region R1 along the Y-axis and green light GL2 passing through the second region R2 along the Y-axis is whether the multilayer film 571 is present. The optical path length difference between the green light GL1 and the green light GL2 is therefore equal to the optical path length difference ΔOP.

$$Δ OP = {\sum }_{i = 1}^{k} {n}_{i} \times {d}_{i} - n 0 \times d 0 \qquad ( 2 )$$

The phase difference between the two types of green light GL calculated from the optical path length difference ΔOP changes the degree of illuminance unevenness of the green light GL emitted from the optical element 521 toward the +Y side along the Y-axis and the influence of a diffraction phenomenon on the pattern F.

FIG. 6 shows an example of a graph representing the relationship between the optical path length difference ΔOP and the phase difference between the two types of the green light GL. In the numerical calculation to derive the graph shown in FIG. 6, the center wavelength of the green light GL is set at 550 nm. In FIG. 6, the horizontal axis represents the optical path length difference ΔOP between the green light GL1 and the green light GL2, and the vertical axis represents a phase difference OG between the green light GL1 and the green light GL2. In the numerical calculation, the phase difference OG is calculated within a range from −180° to +180°. The optical path length difference ΔOP and the phase difference OG are correlated with each other; specifically, there is a linear relationship between the optical path length difference ΔOP and the phase difference φG, as shown in FIG. 6.

FIG. 7 is a diagrammatic view illustrating the diffraction phenomenon of the green light GL passing through the optical element 521. To facilitate understanding of the diffraction phenomenon, consider two imaginary point light sources OR1 and OR2 separate from each other. The green light GL1 is radially emitted from the point light source OR1, and the green light GL2 is radially emitted from the point light source OR2, as shown in FIG. 7. In FIG. 7, the positions corresponding to the peaks of the waves of the green light GL are expressed by solid lines, and the positions corresponding to the bottoms of the waves of the green light GL are expressed by broken lines.

When the phase difference OG is 0°, the green light GL1 and the green light GL2 are in phase, as shown in FIG. 7 by way of example. At a position PS, positions T1 corresponding to the peaks of the waves of the green light GL1 and the green light GL2 coincide with each other, and positions s B1 corresponding to the bottoms of the waves of the green light GL1 and the green light GL2 coincide with each other, so that the green light GL1 and the green light GL2 strengthen each other.

Although not shown, when the phase difference φG increases from 0° to, for example, about 180°, the optical path length difference ΔOP becomes about 0.5 times the center wavelength of the green light GL. In this case, at the position PS, the positions T1 corresponding to the peaks of the waves of the green light GL1 coincide with positions B2 corresponding to the bottoms of the waves of the green light GL2, so that the green light GL1 and the green light GL2 weaken each other.

When the phase difference OG increases from 180° to, for example, about 360°, the optical path length difference ΔOP becomes about one times the center wavelength of the green light GL. In this case, at the position PS, the positions T1 corresponding to the peaks of the waves of the green light GL1 coincide with positions T2 corresponding to the bottoms of the waves of the green light GL2, so that the green light GL1 and the green light GL2 strengthen each other.

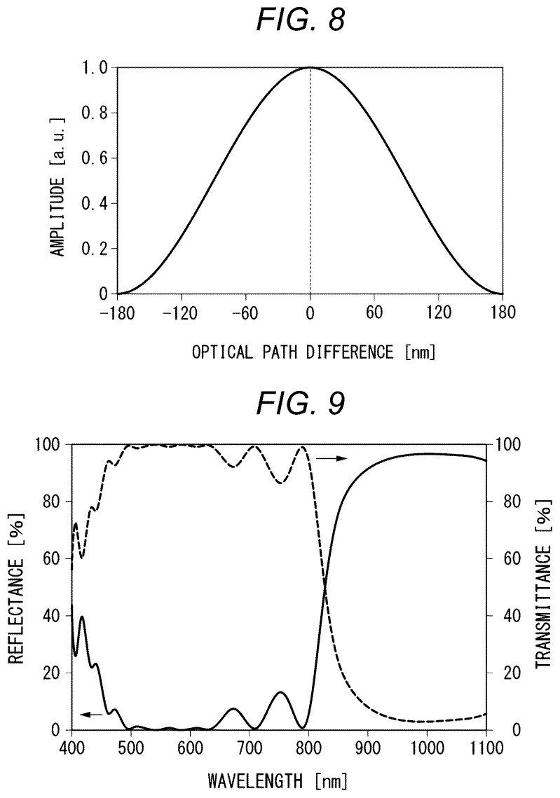

FIG. 8 shows a graph representing the relationship between the phase difference OG and the amplitude of the green light GL calculated under the same conditions under which the numerical calculation related to the graph in FIG. 6 is performed. When the phase difference OG is 0°, the zero-order green light GL has the largest amplitude, which is a relative number of 1, so that the green light GL has the highest brightness, as shown in FIG. 8. When the phase difference OG is 180°, the zero-order green light GL has a smaller amplitude, so that the green light GL has a lower brightness than those provided when the phase difference OG is 0°. When the phase difference φG becomes 360°, which is outside the range of the graph in FIG. 8, the amplitude of the zero-order green light GL increases again, so that the brightness of the green light GL increases.

When the green light GL1 and the green light GL2 are diffracted at, for example, the boundary between the first region R1 and the second region R2, that is, the circumferential edge of the multilayer film 571, the phase difference OG should be at least 90° or smaller, preferably 60° or smaller, desirably close to 0° to suppress the resultant illuminance unevenness of the green light GL emitted from the optical element 521 and minimize the resultant generation of the pattern F. The optical path length difference ΔOP should be close to a natural number multiple of the center wavelength of the green light GL, preferably, for example, greater than or equal to (k−0.1) times but smaller than or equal to (k+0.1) times the reference wavelength of the green light GL, where k is a natural number.

In the actual optical element 521, the light source of the green light GL is present in a plane containing the X-axis and the Z-axis, and the incident green light GL has an illuminance distribution derived from the characteristics of the light source apparatus 100 of the illuminator 20, that is, illuminance depending on the angle. In consideration of the above, even when the phase difference OG is 180°, the relative intensity of the zero-order green light GL in the light exiting direction is not zero, but is averaged because the green light GL is incident in all directions. A decrease in the brightness of the green light GL is therefore very small.

In the actual use of the projector 11 and an experiment conducted by the discloser of the present disclosure, it has been ascertained that the unevenness of the displayed green light G is favorably reduced when the phase difference OG is at least greater than or equal to −90° but smaller than or equal to 90°, preferably greater than or equal to −60° but smaller than or equal to 60°. To more strictly predict the unevenness of the displayed green light G, it is necessary to perform numerical calculation using a finite difference time domain (FDTD) method, and to reflect detailed conditions of the optical system of the projector 11.

### Design Examples of Optical Element

A design example <1> of the multilayer films 522 and 571 in consideration of the aforementioned behaviors of the green light GL and the infrared light IL in the optical element 521 will next be described. Table 1 shows the layer number of a refractive index layer counted from the +Y side, the material of the refractive index layer, and the thickness of the refractive index layer in the first region R1 and the second region R2 in the multilayer film 522 of the optical element 521 in the first embodiment, and further shows the layer number of a refractive index layer counted from the +Y side, the material of the refractive index layer, and the thickness dL or dH of the refractive index layer in the first region R1 in the multilayer film 571.

TABLE 1

| | |
|---|---|
| Layer | Thickness [nm] |

| | number | Material | R2 | R1 |
|---|---|---|---|---|
| 552 | 1 | SiO₂ | 50.0 | 50.0 |
| | 2 | Nb₂O₅ | 20.7 | 20.7 |
| | 3 | SiO₂ | 31.5 | 31.5 |
| | 4 | Nb₂O₅ | 88.6 | 88.6 |
| | 5 | SiO₂ | 17.5 | 17.5 |
| | 6 | Nb₂O₅ | 42.0 | 42.0 |
| | 7 | SiO₂ | 114.4 | 114.4 |
| 571 | 1 | SiO₂ | — | 79.1 |
| | 2 | Nb₂O₅ | — | 102.6 |
| | 3 | SiO₂ | — | 170.9 |
| | 4 | Nb₂O₅ | — | 106.0 |
| | 5 | SiO₂ | — | 168.0 |
| | 6 | Nb₂O₅ | — | 101.9 |
| | 7 | SiO₂ | — | 170.3 |
| | 8 | Nb₂O₅ | — | 106.0 |
| | 9 | SiO₂ | — | 169.9 |
| | 10 | Nb₂O₅ | — | 96.9 |
| | 11 | SiO₂ | — | 75.8 |

In the design example <1>, the material of the low refractive index layers of the multilayer film 522 is SiO₂, and the material of the high refractive index layers of the multilayer film 522 is Nb₂O₅, as shown in Table 1. The thickness of each of the low refractive index layers of the multilayer film 522, that is, the size of each of the low refractive index layers of the multilayer film 522 along the Y-axis is the same in the first region R1 and the second region R2. Similarly, the thickness of each of the high refractive index layers of the multilayer film 522, that is, the size of each of the high refractive index layers of the multilayer film 522 along the Y-axis is the same in the first region R1 and the second region R2.

In the design example <1>, the material of the low refractive index layers 561 of the multilayer film 571 is SiO₂, and the material of the high refractive index layers 562 of the multilayer film 571 is Nb₂O₅.

FIG. 9 shows graphs representing the wavelength dependence of the reflectance and transmittance of the first region R1, on which the light is incident from the −Y side along the Y-axis, in the design example <1> of the optical element 521. In FIG. 9, the horizontal axis represents the wavelength of the light incident on the first region R1. In FIG. 9, the vertical axis represents the reflectance of the first region R1, which reflects the light toward the −Y side, and the transmittance of the first region R1, on which the light is incident, at each wavelength of the light.

In the design example <1>, when the wavelength band of the light incident on the first region R1 is longer than or equal to 500 nm but shorter than or equal to 600 nm, the reflectance of the first region R1 that reflects the light is suppressed to a value higher than or equal to 0% but lower than or equal to 2%, as shown in FIG. 9. Therefore, the green light GL reflected off the first region R1 in the design example <1> of the optical element 521 is very weak, and an observer is unlikely to visually recognize, for example, the pattern in the image light enlarged and projected onto the screen SCR shown in FIG. 1. When the wavelength band of the light incident on the first region R1 is longer than or equal to 900 nm but shorter than or equal to 1000 nm, the reflectance of the first region R1 that reflects the light is higher than or equal to 90% but lower than or equal to 96%.

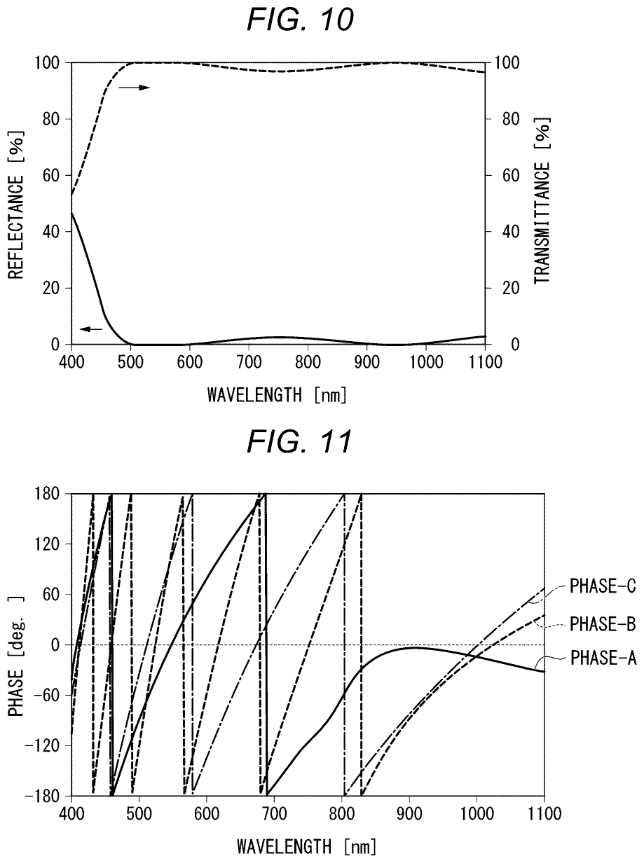

FIG. 10 shows graphs representing the wavelength dependence of the reflectance and transmittance of the second region R2, on which the light is incident from the −Y side along the Y-axis, in the design example <1> of the optical element 521. In FIG. 10, the horizontal axis represents the wavelength of the light incident on the second region R2. In FIG. 10, the vertical axis represents the reflectance of the second region R2, which reflects the light toward the −Y side, and the transmittance of the second region R2, on which the light is incident, at each wavelength of the light.

In the design example <1>, even when the wavelength band of the light incident on the second region R2 is longer than or equal to 500 nm but shorter than or equal to 600 nm, or longer than or equal to 900 nm but shorter than or equal to 1000 nm, the reflectance of the second region R2, which reflects the light, is suppressed to a value higher than or equal to 0% but lower than or equal to 18, as shown in FIG. 10.

From the results described above, it is understood that when the green light GL having a uniform illuminance distribution in a plane containing the X-axis and the Z-axis enters the optical element 521 of the design example <1> from the −Y side along the Y-axis, the green light GL having a uniform illuminance distribution in the plane containing the X-axis and the Z-axis is emitted toward the +Y side as in the case of the incidence of the light, as diagrammatically shown in FIG. 4 by way of example. It is understood that when the infrared light IL having a uniform illuminance distribution in a plane containing the X-axis and the Z-axis enters the optical element 521 of the design example <1> from the −Y side along the Y-axis, the infrared light IL having an illuminance distribution containing the pattern F is emitted toward the +Y side, as diagrammatically shown in FIG. 5 by way of example.

In the design example <1>, the optical path length difference ΔOP between the two types of green light GL at the center wavelength of 550 nm thereof depends on the optical path length of the green light GL from the first low refractive index layer 561 to the eleventh low refractive index layer 561 of the multilayer film 571 in the first region R1. The optical path length of the green light GL1 in the first region R1 is expressed by {(refractive index nL of SiO₂ at 550 nm; 1.47)×(total thickness dL of SiO₂ in multilayer film 571; 834.00 nm)}+{(refractive index nH of Nb₂O₅ at 550 nm; 2.37)×(total thickness dH of Nb₂O₅ in multilayer film 571; 513.40 nm)}, and is 2442.74 nm. The optical path length of the green light GL2 in the second region R2 is expressed by (refractive index n0 of air; 1.00)×(thickness d0 of multilayer film 571; 1347.40 nm), and is 1347.40 nm.

The optical path length difference ΔOP between the two types of green light GL at the center wavelength of 550 nm thereof is 1095.34 nm, corresponds (1095.34/550) wavelengths, which is a shift of 1.99 wavelengths, that is, about two wavelengths.

FIG. 11 shows graphs representing the wavelength dependence of the phase of the light incident on and passing through the first region R1 and the second region R2 from the −Y side along the Y-axis in the design example <1> of the optical element 521. In FIG. 11, the horizontal axis represents the wavelength of the light incident on the first region R1 and the second region R2. In FIG. 11, the vertical axis represents the phase of the light incident on and passing through the first region R1 and the second region R2 toward the +Y side at each wavelength of the light. The graph labeled with PHASE-A in FIG. 11 represents the phase difference between the phase of the light incident on and passing through the first region R1 and the phase of the light incident on and passing through the second region R2. The graph labeled with PHASE-B in FIG. 11 represents the phase of the light incident on and passing through the first region R1. The graph labeled with PHASE-C in FIG. 11 represents the phase of the light incident on and passing through the second region R2.

PHASE-A changes in accordance with the relative relationship between PHASE-B and PHASE-C together with the wavelength of the light incident on the first region R1 and the second region R2 of the optical element 521, as shown in FIG. 11. In the wavelength band of the green light GL ranging from 500 nm to 600 nm, PHASE-A increases from about −90.00° to about +87.00° as the wavelength increases. At the center wavelength of the green light GL, PHASE-A is nearly 0° and is about 3°.

In the design example <1>, the phase difference OG at the center wavelength of 550 nm of the green light GL is expressed by {remainder of (1.99/1.00)}×360°, is 356.40° to be accurate, equal to −3.60°, about 360°, that is, about 0°. The phase difference OG between the two types of green light GL, which belong to the wavelength band longer than or equal to 500 nm but shorter than or equal to 600 nm, ranges from −81.00° to 80.00°.

In the optical element 521 according to the first embodiment, the effective refractive index and thickness d0 of the multilayer film 571, which are the difference in the optical configuration between the first region R1 and the second region R2, are so set that the phase difference φG between the green light GL1 and the green light GL2 is greater than or equal to −90° but smaller than or equal to 90°, and that the infrared light IL incident on the first region R1 is reflected toward the −Y side and therefore blocked, as specifically shown by the design example <1>. In detail, the refractive index nL and the thickness dL of each of the low refractive index layers 561, the refractive index nH and the thickness dH of each of the high refractive index layers 562, and the total number of the refractive index layers in the multilayer film 571 are so set that the phase difference φG is greater than or equal to −90° but smaller than or equal to 90° and the infrared light IL incident on the first region R1 is blocked.

According to the aforementioned design of the multilayer film 571, when the green light GL is incident on the optical element 521 from the −Y side along the Y-axis, and even when the green light GL1 and the green light GL2 are scattered or diffracted at the circumferential edge of the multilayer film 571 in the second region R2, the phase difference OG is greater than or equal to −90° but smaller than or equal to 90°, so that the situation in which the green light GL1 and the green light GL2 weaken each other can be suppressed, the illuminance unevenness of the green light GL emitted from the optical element 521 toward the +Y side in a plane containing the X-axis and the Z-axis can be reduced, and the generation of the pattern in the green light GL in accordance with the predetermined pattern F can be reduced. When the infrared light IL is incident on the optical element 521 from the −Y side along the Y-axis, the infrared light IL is favorably blocked by the multilayer film 571 in the second region R2, so that the infrared light IL emitted from the optical element 521 toward the +Y side can contain a clear pattern formed in the plane containing the X-axis and the Z-axis.

The refractive index nL and the thickness dL of each of the low refractive index layers 561, the refractive index nH and the thickness dH of each of the high refractive index layers 562, and the total number of the refractive index layers in the multilayer film 571 are so set that the optical path length difference ΔOP between the green light GL1 and the green light GL2 is greater than or equal to (k−0.1) times but smaller than or equal to (k+0.1) times the reference wavelength of the green light GL and the infrared light IL incident on the first region R1 is blocked. The configuration described above can suppress occurrence of illuminance unevenness of the green light GL emitted from the optical element 521, suppress generation of patterned light derived from the green light GL, and make patterned light derived from the infrared light IL clear, as in the case where the multilayer film 571 is so designed that the phase difference OG is greater than or equal to −90° but smaller than or equal to 90°.

### Optical Element and Design Example in Related Art

A description will be subsequently made about a configuration and a design example <2> in a case where the multilayer film 571 is not so designed that the phase difference OG between the green light GL1 and the green light GL2 is greater than or equal to −90° but smaller than or equal to 90° as in related art.

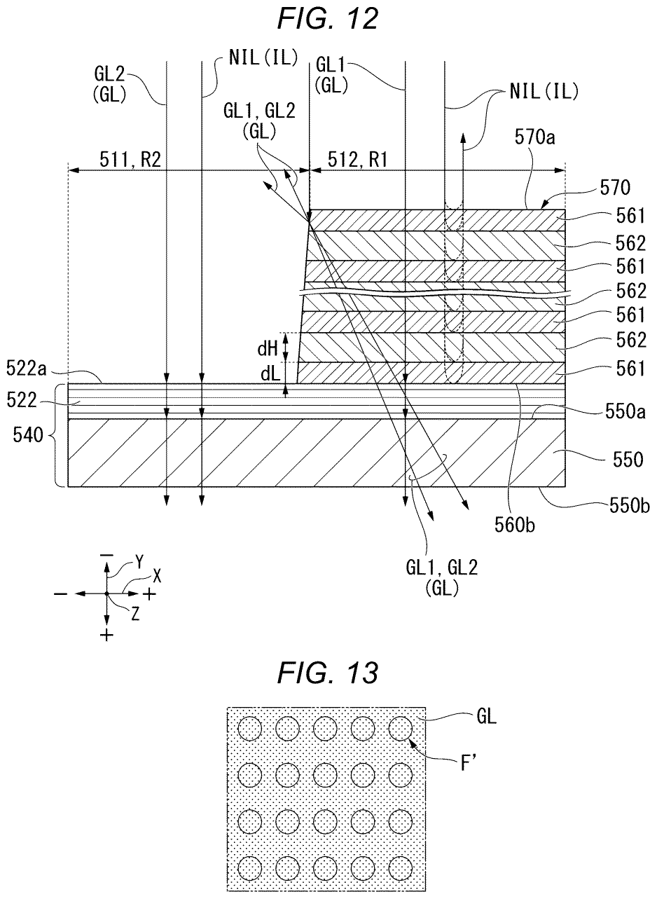

FIG. 12 is a cross-sectional view of key portions of an optical element of related art, and corresponds to a cross-sectional view taken along the line III-III shown in FIG. 2. The optical element of related art is configured with the substrate 550 and a multilayer film 570, as shown in FIG. 12.

The multilayer film 570 is formed at the surface 522a of the multilayer film 522 in the first region R1 and is layered on the −Y side of the substrate 550, as the multilayer film 571. The multilayer film 570 is a multilayer film configured with the low refractive index layers 561 and the high refractive index layers 562, and is, for example, a dielectric multilayer film. Specifically, the multilayer film 570 is a film in which the low refractive index layers 561 and the high refractive index layers 562 are alternately layered on each other along the Y-axis. A low refractive index layer 561 is disposed on the side closest to the +Y side of the multilayer film 570, and another low refractive index layer 561 is disposed on the side closest to the −Y side of the multilayer film 570.

However, the thickness dL of each of the low refractive index layers 561, the thickness dH of each of the high refractive index layers 562, and the total number of the refractive index layers in the multilayer film 570 differ from the thickness dL of each of the low refractive index layers 561, the thickness dH of each of the high refractive index layers 562, and the total number of the refractive index layers in the multilayer film 571. That is, in the optical element of related art, the refractive index nL and the thickness dL of each of the low refractive index layers 561, the refractive index nH and the thickness dH of each of the high refractive index layers 562, and the total number of the refractive index layers in the multilayer film 570 are so set that the phase difference OG is smaller than −90° or greater than 90° and the optical path length difference ΔOP between the green light GL1 and the green light GL2 is smaller than (k−0.1) times or greater than (k+0.1) times the reference wavelength of the green light GL.

The infrared light IL that enters the multilayer film 570 of the optical element of related art from the −Y side along the Y-axis undergoes multiple reflection at the interfaces between the low refractive index layers 561 and the high refractive index layers 562, which are alternately layered on each other, and as a result, the infrared light IL is reflected toward the −Y side of the multilayer film 570 and is not emitted toward the +Y side of the multilayer film 570.

The green light GL1 incident on the optical element of related art basically passes through the blocking portions 512 and the first region R1. The green light GL2 incident on the optical element of related art passes through t the transmissive portion 511 and the second region R2. However, the phase difference OG between the green light GL1 and the green light GL2 scattered or diffracted, for example, at the circumferential edge of the multilayer film 570 is not greater than or equal to −90° but smaller than or equal to 90°, and the optical path length difference ΔOP between the green light GL1 and the green light GL2 scattered or diffracted, for example, at the circumferential edge of the multilayer film 570 is not greater than or equal to (k−0.1) times but smaller than or equal to (k+0.1) times the reference wavelength of the green light GL. Therefore, the green light GL1 and the green light GL2, for example, scattered or diffracted at the circumferential edge of the multilayer film 570 and therefore caused to overlap with each other in the optical path therefore weaken each other.

FIG. 13 is a diagrammatic view of a portion of an illuminance pattern, in a plane containing the X-axis and the Z-axis, of the green light GL emitted from the optical element of related art toward the +Y side along the Y-axis. A pattern F′ is generated in the illuminance of the green light GL emitted from the optical element toward the +Y side in a plane containing the X-axis and the Z-axis, as shown in FIG. 13. The pattern F′ is a pattern derived from the predetermined pattern F, having multiple rings, and overlapping with the circumferential edge of the multilayer film 570 when viewed along the Y-axis. In practice, the green light GL1 and the green light GL2 scattered or diffracted at the circumferential edge of the multilayer film 570 weaken each other as described above, so that the illuminance and the optical intensity of the green light GL at the rings are lower than those at the other portions around the rings.

Although not shown, the illuminance of the infrared light IL emitted from the optical element of related art toward the +Y side at the blocking portion 512 in the plane containing the X-axis and the Z-axis is lower than the illuminance at the transmissive portion 511, as in the optical element 521. The pattern F′ is therefore formed in the infrared light IL emitted from the optical element of related art toward the +Y side.

Table 2 shows the layer number of a refractive index layer counted from the +Y side, the material of the refractive index layer, and the thickness of the refractive index layer in the first region R1 and the second region R2 in the multilayer film 522 of the optical element, which is not shown, and further shows the layer number of a refractive index layer counted from the +Y side, the material of the refractive index layer, and the thickness dL or dH of the refractive index layer in the first region R1 in the multilayer film 570.

TABLE 2

| | |
|---|---|
| Layer | Thickness [nm] |

| | number | Material | R2 | R1 |
|---|---|---|---|---|
| 552 | 1 | SiO₂ | 50.0 | 50.0 |
| | 2 | Nb₂O₅ | 20.7 | 20.7 |
| | 3 | SiO₂ | 31.5 | 31.5 |
| | 4 | Nb₂O₅ | 88.6 | 88.6 |
| | 5 | SiO₂ | 17.5 | 17.5 |
| | 6 | Nb₂O₅ | 42.0 | 42.0 |
| | 7 | SiO₂ | 114.4 | 114.4 |
| 570 | 1 | SiO₂ | — | 56.5 |
| | 2 | Nb₂O₅ | — | 93.7 |
| | 3 | SiO₂ | — | 141.7 |
| | 4 | Nb₂O₅ | — | 104.2 |
| | 5 | SiO₂ | — | 174.3 |
| | 6 | Nb₂O₅ | — | 105.6 |
| | 7 | SiO₂ | — | 138.5 |
| | 8 | Nb₂O₅ | — | 94.2 |
| | 9 | SiO₂ | — | 53.5 |

In the design example <2>, the material and the refractive index of each of the low refractive index layers and the high refractive index layers, and the total number of the refractive index layers in the multilayer film 522 are set in the same manner as in the design example <1>, as shown in Table 2. In the design example <2>, the total number of the refractive index layers provided in the multilayer film 570 is nine, which is smaller than the total number of the refractive index layers provided in the multilayer film 571 of the optical element 521 according to the first embodiment.

In the design example <2>, whether the first to ninth refractive index layers counted from the −Y side in the multilayer film 570 are each the low refractive index layer 561 or the high refractive index layer 562 is the same as in the design example <1>. That is, the first refractive index layer of the multilayer film 570 is the low refractive index layer 561 made of SiO₂, the second refractive index layer of the multilayer film 570 is the high refractive index layer 562 made of Nb₂O₅, and the ninth refractive index layer of the multilayer film 570 is the low refractive index layer 561 made of SiO₂.

However, the thickness of each of the first to ninth refractive index layers in the multilayer film 570 differs from the thickness of each of the corresponding first to ninth refractive index layers in the multilayer film 571.

That is, the thickness dL of the first low-refractive-index layer 561 of the multilayer film 570 differs from the thickness dL of the first low-refractive-index layer 561 of the multilayer film 571. The thickness dH of the second high-refractive-index layer 562 of the multilayer film 570 differs from the thickness dH of the second high-refractive-index layer 562 of the multilayer film 571.

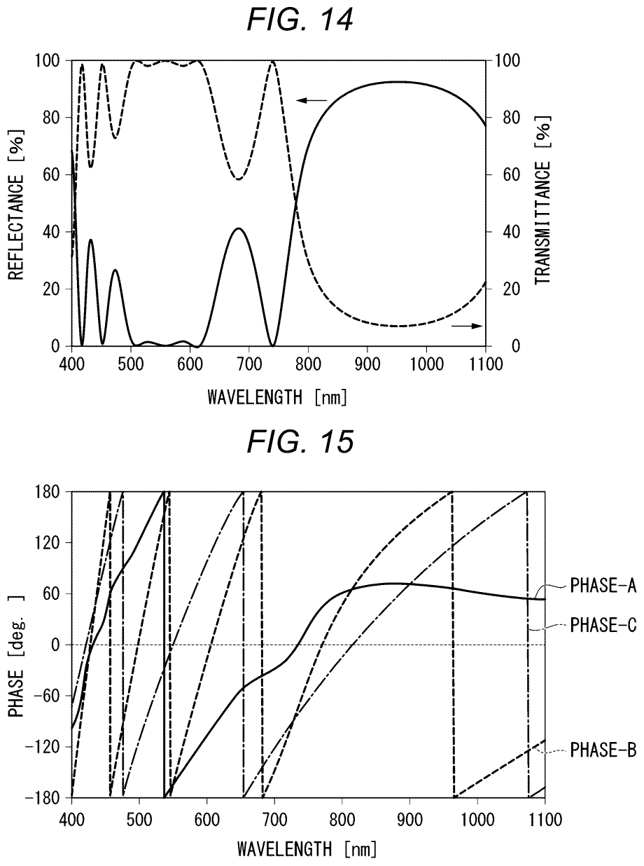

FIG. 14 shows graphs representing the wavelength dependence of the reflectance and transmittance of the first region R1, on which the light is incident from the −Y side along the Y-axis, in the design example <2> of the optical element of related art. In FIG. 14, the horizontal axis represents the wavelength of the light incident on the first region R1. In FIG. 14, the vertical axis represents the reflectance of the first region R1, which reflects the light toward the −Y side, and the transmittance of the first region R1, on which the light is incident, at each wavelength of the light.

In the design example <2>, when the wavelength band of the light incident on the first region R1 is longer than or equal to 500 nm but shorter than or equal to 600 nm, the reflectance of the first region R1 that reflects the light is suppressed to a value higher than or equal to 0% but lower than or equal to 2%, as in the design example <1>, as shown in FIG. 14. When the wavelength band of the light incident on the first region R1 is longer than or equal to 900 nm but shorter than or equal to 1000 nm, the reflectance of the first region R1 that reflects the light is higher than or equal to 90% but lower than or equal to 92%.

Although not shown, the graph representing the wavelength dependence of the reflectance of the second region R2 that reflects the light incident from the −Y side along the Y-axis in the design example <2> of the optical element of related art is the same as that shown in FIG. 10.

In the design example <2>, the optical path length difference ΔOP between the two types of green light GL at the center wavelength of 550 nm thereof depends on the optical path length of the green light GL from the first low refractive index layer 561 to the ninth low refractive index layer 561 of the multilayer film 570 in the first region R1. The optical path length of the green light GL1 in the first region R1 is expressed by {(refractive index nL of SiO₂ at 550 nm; 1.47)×(total thickness of SiO₂ in multilayer film 570; 564.50 nm)}+{(refractive index nH of Nb₂O₅ at 550 nm; 2.37)×(total thickness of Nb₂O₅ in multilayer film 570; 397.70 nm)}, and is 1772.36 nm. The optical path length of the green light GL2 in the second region R2 is expressed by (refractive index n0 of air; 1.00)×(thickness d0 of multilayer film 570; 962.20 nm), and is 962.20 nm.

In the design example <2>, the optical path length difference ΔOP between the two types of green light GL at the center wavelength of 550 nm thereof is 810.16 nm, corresponds to (810.16/550) wavelengths, which is a shift of 1.47 wavelengths, that is, about 1.5 wavelengths.

FIG. 15 shows graphs representing the wavelength dependence of the phase of the light incident on and passing through the first region R1 and the second region R2 from the −Y side along the Y-axis in the design example <2> of the optical element of related art. In FIG. 15, the horizontal axis represents the wavelength of the light incident on the first region R1 and the second region R2. In FIG. 15, the vertical axis represents the phase of the light incident on and passing through the first region R1 and the second region R2 toward the +Y side at each wavelength of the light. The graph labeled with PHASE-A in FIG. 15 represents the phase difference between the phase of the light incident on and passing through the first region R1 and the phase of the light incident on and passing through the second region R2. The graph labeled with PHASE-B in FIG. 15 represents the phase of the light incident on and passing through the first region R1. The graph labeled with PHASE-C in FIG. 15 represents the phase of the light incident on and passing through the second region R2.

PHASE-A changes in accordance with the relative relationship between PHASE-B and PHASE-C together with the wavelength of the light incident on the first region R1 and the second region R2 of the optical element of related art, as shown in FIG. 15. In the wavelength band of the green light GL from 500 nm to 600 nm, as the wavelength increases from 500 nm to 530 nm, PHASE-A increases from about 140.00° to +180.00°, and temporarily becomes comparable to −180.00°. As the wavelength increases from 530 nm to 600 nm, PHASE-A gradually changes from −180.00° to about −120.000. At the center wavelength of the green light GL, PHASE-A is about −150°.

As described above, in the optical element of related art, since the phase difference OG between the green light GL1 and the green light GL2 is close to −180° or 180°, and the optical path length difference ΔOP between the green light GL1 and the green light GL2 corresponds to 1.5 wavelengths, illuminance unevenness is likely to occur in the green light GL emitted toward the +Y side, and the green light GL containing the pattern F′ is formed.

### Method for Producing Optical Element

A method of producing the optical element 521 according to the first embodiment will next be described. As the method for producing the optical element 521 according to the first embodiment, for example, a production method 1 and a production method 2 using a lift-off technology, and a production method 3 and a production method 4 using an etching technology will be briefly described.

### Production Method 1

The multilayer film 522 is first deposited at the plate surface 550a of the substrate 550. A photoresist is next applied only to the −Y-side surface 522a of the multilayer film 522 in the second region R2, and is exposed and developed. The multilayer film 571 is subsequently deposited at the surface 522a of the multilayer film 522 in the first region R1 and the −Y-side surface of the photoresist in the second region R2. The photoresist in the second region R2 is then removed together with the multilayer film 571 on the −Y side to expose the surface 522a of the multilayer film 522 in the second region R2.

The optical element 521 is produced by the steps described above. In the production method 1, patterning and photolithography are performed once, and film deposition is performed twice.

### Production Method 2

A photoresist is first applied only to the plate surface 550a of the substrate 550 in the second region R2, and is exposed and developed. The multilayer film 571 is then deposited at the plate surface 550a of the substrate 550 in the first region R1 and the −Y-side surface of the photoresist in the second region R2. The photoresist in the second region R2 is subsequently removed together with the multilayer film 571 on the −Y side to expose the plate surface 550a of the substrate 550 in the second region R2. The multilayer film 522 is then deposited at a −Y-side surface 571a of the multilayer film 571 in the first region R1 and the plate surface 550a of the substrate 550 in the second region R2.

The optical element that is not shown but is designed in accordance with the first embodiment is produced by the steps described above. In the optical element produced by the production method 2, which is the optical element 521 shown in FIG. 3, the multilayer film 571 is formed at the plate surface 550a of the substrate 550 in the first region R1, and the multilayer film 522 in the first region R1 is formed at the surface 571a of the multilayer film 571. The optical element produced by the production method 2 provides the same effects and advantages provided by the optical element 521. In the production method 2, patterning and photolithography are performed once, and film deposition is performed twice.

### Production Method 3

The multilayer film 571 is first deposited at the plate surface 550a of the substrate 550 in the first region R1 and the second region R2. A photoresist is next applied only to the surface 571a of the multilayer film 571 in the first region R1, and is exposed and developed. The multilayer film 571 in the second region R2 is subsequently removed, for example, by dry etching using the photoresist as a mask. Furthermore, the photoresist in the first region R1 is removed to expose the surface 571a of the multilayer film 571 in the first region R1 and the plate surface 550a of the substrate 550 in the second region R2. The multilayer film 522 is then deposited at the surface 571a of the multilayer film 571 in the first region R1 and the plate surface 550a of the substrate 550 in the second region R2.

The optical element that is not shown but is designed in accordance with the first embodiment is produced by the steps described above. The optical element produced by the production method 3 is configured in the same manner as the optical element produced by the production method 2, and provides the same effects and advantages provided by the optical element 521. In the production method 3, patterning and photolithography are performed once, film deposition is performed twice, and etching is performed once.

### Production Method 4

The multilayer films 522 and 571 are first sequentially deposited at the plate surface 550a of the substrate 550 in the first region R1 and the second region R2. A photoresist is next applied only to the surface 571a of the multilayer film 571 in the second region R2, and is exposed and developed. The multilayer film 571 in the second region R2 is subsequently removed, for example, by dry etching using the photoresist as a mask. The photoresist in the first region R1 is then removed.

The optical element 521 is produced by the steps described above. In the production method 4, patterning and photolithography are performed once, film deposition is performed once, and etching is performed once.

According to any of the production methods 1 to 4, the optical element 521 according to the first embodiment, and an optical element providing the same effects and advantages provided by the optical element 521 can be readily produced at low cost through patterning and photolithography performed once.

### SUMMARY

The optical element 521 according to the first embodiment described above includes the substrate 550 and the multilayer film (first optical layer) 571. The substrate 550 transmits the green light (first light) GL having a green visible wavelength band (first wavelength band) and the infrared light (second light) IL having an infrared wavelength band (second wavelength band) different from the green wavelength band. The multilayer film 571 is disposed on the −Y side of the substrate 550, that is, in the first region R1 of the plate surface (first surface) 550a, which is the surface on which the green light GL and the infrared light IL is incident, via the multilayer film 522 in the Y-axis. In the optical element 521 according to the first embodiment, the refractive index and the thickness of the multilayer film 571 are determined, for example, by the refractive index nL and the thickness dL of each of the low refractive index layers 561, which constitute the multilayer film 571, and the refractive index nH and the thickness dH of each of the high refractive index layers 562, which constitute the multilayer film 571. The refractive index nL and the thickness dL of each of the low refractive index layers 561, and the refractive index nH and the thickness dH of each of the high refractive index layers 562 are so set that the phase difference OG between the green light GL1 and the green light GL2 is greater than or equal to −90° but smaller than or equal to 90° and the infrared light IL incident on the first region R1 is blocked. The green light GL1 is contained in the green light GL having the center wavelength (centrobaric wavelength) and passing through the first region R1. The green light GL2 is contained in the green light GL having the center wavelength and passing through the second region R2 other than the first region R1 in a plane containing the X-axis and the Z-axis parallel to the plate surface 550a of the substrate 550.

In the optical element 521 according to the first embodiment, the green light GL1 is incident on the first region R1 from the −Y side along the Y-axis, and the green light GL2 is incident on the second region R2 from the −Y side along the Y-axis, and very small part of the green light GL1 and GL2 is scattered or diffracted at the circumferential edge of the multilayer film 571. The optical element 521 according to the first embodiment, in which the phase difference φG is greater than or equal to −90° but smaller than or equal to 90°, can suppress the situation in which the green light GL1 and the green light GL2 scattered or diffracted at the circumferential edge of the multilayer film 571 weaken each other, can suppress occurrence of illuminance unevenness of the green light GL, and prevent the green light GL that does not originally generate patterned light from generating patterned light containing the pattern F′. The optical element 521 according to the first embodiment, in which the infrared light IL is incident on the first region R1 and the second region R2 from the −Y side along the Y-axis, and the infrared light IL incident on the first region R1 is reflected off the multilayer film 571 toward the −Y side and therefore blocked on the +Y side, allows even the infrared light IL to favorably patterned light containing the pattern F.

The optical element 521 according to the first embodiment includes the substrate 550 and the multilayer film (first optical layer) 571. The refractive index nL and the thickness dL of each of the low refractive index layers 561 of the multilayer film 571 and the refractive index nH and the thickness dH of each of the high refractive index layers 562 of the multilayer film 571 are so set that the optical path length difference ΔOP between the green light GL1 and the green light GL2 is a natural number multiple of the center wavelength of the green light GL and the infrared light IL incident on the first region R1 is blocked. Specifically, the optical path length difference ΔOP being a natural number multiple of the center wavelength of the green light GL means that the optical path length difference ΔOP is greater than or equal to (k−0.1) times but smaller than or equal to (k+0.1) times the center wavelength of the green light GL.

The optical element 521 according to the first embodiment, in which the optical path length difference ΔOP is greater than or equal to (k−0.1) times but smaller than or equal to (k+0.1) times the center wavelength of the green light GL, can suppress the situation in which the green light GL1 and the green light GL2 scattered or diffracted at the circumferential edge of the multilayer film 571 weaken each other, suppress occurrence of illuminance unevenness of the green light GL emitted toward the +Y side along the Y-axis, and prevent the green light GL that does not originally generate patterned light from generating patterned light containing the pattern F′, as in the state in which the phase difference φG is greater than or equal to −90° but smaller than or equal to 90°.

In the optical element 521 according to the first embodiment, the −Y side of the multilayer film 571, that is, the surface (second surface) 571a, on which the green light GL and the infrared light IL are incident, is exposed to the air.

The optical element 521 according to the first embodiment can suppress the occurrence of the illuminance unevenness of the green light GL, can prevent the green light GL that does not originally generate patterned light from generating patterned light containing the pattern F′, and can be readily produced at low cost by using any of the production methods 1 to 4 based, for example, on the lift-off or etching technology described above.

The optical element 521 according to the first embodiment further includes the multilayer film 522. The multilayer film 522 is disposed at the plate surface 550a of the substrate 550 in the first region R1 and the second region R2 and is in contact with the substrate 550. The multilayer film 571 is formed on the −Y side of the multilayer film 522 in the first region R1, that is, the surface (third surface) 522a, on which the green light GL and the infrared light IL are incident.

The optical element 521 according to the first embodiment can suppress the occurrence of illuminance unevenness of the green light GL, and prevent the green light GL that does not originally generate patterned light from generating patterned light containing the pattern F′. In a cross-sectional view of the optical element 521 according to the first embodiment taken along a plane containing the Y-axis and perpendicular to a plane containing the X-axis and the Z-axis, the total thickness of the substrate 550 and the multilayer film 522 in the first region R1 differs from the total thickness of the substrate 550 and the multilayer films 522 and 571 in the second region R2. In the optical element 521 according to the first embodiment, the multilayer film 522, which transmits the green light GL, is formed across both the first region R1 and the second region R2, and the multilayer film 571, which reflects the infrared light IL toward the −Y side and therefore blocks the infrared light IL on the +Y side, is formed in the first region R1. Therefore, when the optical element 521 is produced by using, for example, any of the production methods 1 to 4 described above, patterning needs to be performed only once, so that the optical element 521 can be readily produced at low cost.

The surface 571a of the multilayer film 571 of the optical element 521 according to the first embodiment is exposed to the air, as shown in FIG. 3 by way of example.

The optical element 521 according to the first embodiment can suppress the occurrence of the illuminance unevenness of the green light GL, prevent the green light GL that does not originally generate patterned light from generating patterned light containing the pattern F′, and can be readily produced at low cost by using the production method 1 or 4 described above using patterning performed once.

Although not shown, as a variation of the optical element 521 according to the first embodiment, the multilayer film 571 may be formed at the surface 522a of the multilayer film 522 in the first region R1 and may be in contact with the substrate 550, or the multilayer film 522 in the first region R1 of the multilayer film 522 may be formed at the surface 571a of the multilayer film 571. In the configuration described above, the surface 522a of the multilayer film 522 in the first region R1 is exposed to the air.

The aforementioned variation of the optical element 521 according to the first embodiment can also suppress the occurrence of the illuminance unevenness of the green light GL emitted from the optical element toward the +Y side, can prevent the green light GL that does not originally generate patterned light from generating patterned light containing the pattern F′, and can be readily produced at low cost by using the production method 2 or 3 described above using patterning performed once.

In the optical element 521 according to the first embodiment, the multilayer film 571 is configured with a dielectric multilayer film including the high refractive index layers 562 and the low refractive index layers 561 having a refractive index lower than that of the high refractive index layers 562.

In the optical element 521 according to the first embodiment, in which the multilayer film 571 is configured with the dielectric multilayer film, the refractive index nL and the thickness dL of each of the low refractive index layers 561 and the refractive index nH and the thickness dH of each of the high refractive index layers 562 can be flexibly adjusted in a way that the phase difference OG between the green light GL1 and the green light GL2 is greater than or equal to −90° but smaller than or equal to 90° or the optical path length difference ΔOP is greater than or equal to (k−0.1) times but smaller than or equal to (k+0.1) times the reference wavelength of the green light GL, so that the effective refractive index and thickness d0 of the multilayer film 571 can be appropriately set. The optical element 521 according to the first embodiment allows a widened range from which the material of each of the low refractive index layers 561 and the high refractive index layers 562 is selected.

In the optical element 521 according to the first embodiment, the green wavelength band of the green light GL is, for example, longer than or equal to 500 nm but shorter than or equal to 600 nm, and therefore falls within the visible wavelength band. The infrared wavelength band of the infrared light IL is, for example, longer than or equal to 900 nm but shorter than or equal to 1000 nm, is therefore a wavelength band longer than the visible wavelength band, and is an invisible wavelength band.

The optical element 521 according to the first embodiment allows the observer to visually recognize the green light GL emitted from the optical element 521 toward the +Y side along the Y-axis as visible color light having a uniform illuminance distribution in a plane containing the X-axis and the Z-axis but not containing the pattern F′. The observer can receive and detect the infrared light IL emitted from the optical element 521 toward the +Y side along the Y-axis as invisible light containing the pattern F by using, for example, the imaging apparatus 710 having sensitivity to the infrared light IL, and can adjust an optical system in which the optical element 521 is disposed without affecting the visible color light.

Since light having an invisible wavelength band is used as the second light, the optical element 521 according to the first embodiment can be used in various apparatuses using invisible light including the infrared light IL or ultraviolet light as a marker. Conceivable examples of the apparatus in which the optical element 521 according to the first embodiment can be used may include an apparatus that maintains real-time freezing or sets interactive coordinate axes, a functional lighting instrument, special lighting that is a combination of visible light and invisible light, and an apparatus that sterilizes a special portion.

In the optical element 521 according to the first embodiment, the invisible light (second light) is the infrared light IL, for example, the near-infrared light NIL.

The optical element 521 according to the first embodiment, in which the infrared wavelength band of the infrared light IL is longer than the visible wavelength band so that the energy of the infrared light IL is relatively lower than the energy of the visible light including the green light GL, can reduce deterioration of the imaging apparatus 710, which captures an image of the infrared light IL, or a detector that detects the infrared light IL.

Note that as a variation of the optical element 521 according to the first embodiment, the wavelength band of the invisible light (second light) may be shorter than the visible wavelength band, and that the invisible light may, for example, be ultraviolet light. In this case, the light emitters 152 each emit ultraviolet light toward the +Y side along the Y-axis. The imaging apparatus 710 of the light source apparatus 150 can capture an image of ultraviolet light.

Also in the aforementioned variation of the optical element 521 according to the first embodiment, the observer can receive and detect the ultraviolet light emitted from the optical element 521 toward the +Y side along the Y-axis as the invisible light containing the pattern F by using, for example, the imaging apparatus 710 having sensitivity to ultraviolet light, and can adjust the optical system in which the optical element 521 is disposed without affecting the visible color light.

In the optical element 521 according to the first embodiment, the phase difference OG between the green light GL1 and the green light GL2 is greater than or equal to −60° but shorter than or equal to 60°.

The optical element 521 according to the first embodiment, in which the phase difference OG between the green light GL1 and the green light GL2 is preferably set at a value greater than or equal to −90° but smaller than or equal to 90° can further suppress the situation in which the green light GL1 and the green light GL2 scattered or diffracted at the circumferential edge of the multilayer film 571 weaken each other, can further suppress the occurrence of illuminance unevenness of the green light GL emitted toward the +Y side, and can prevent the green light GL that does not originally generate patterned light from generating patterned light containing the pattern F′ as much as possible.

The projector 11 (optical instrument) according to the first embodiment includes the optical element 521 according to the first embodiment. Specifically, in the projector 11 according to the first embodiment, the optical element 521 is disposed closer to the −Y side than the light modulator 400G, that is, on a side of the light modulator 400G that is the side on which the green light GL and the infrared light IL are incident. The light modulator 400G converts the green light GL into the green image light, emits the green image light toward the +Y side, and transmits the infrared light IL toward the +Y side.

The projector 11 according to the first embodiment, in which the phase difference OG is greater than or equal to −90° but smaller than or equal to 90° in the optical element 521 or the optical path length difference ΔOP is greater than or equal to (k−0.1) times but smaller than or equal to (k+0.1) times the reference wavelength of the green light GL, can suppress the situation in which the green light GL1 and the green light GL2 scattered or diffracted at the circumferential edge of the multilayer film 571 weaken each other, suppress the occurrence of illuminance unevenness of the green light GL before converted into the image light by the light modulator 400G, and prevent the green light GL that does not originally generate patterned light from generating patterned light containing the pattern F′.

The projector 11 according to the first embodiment can suppress the generation of the pattern F′ in the image light enlarged and projected onto the screen SCR from the projection system 600 disposed downstream of the light modulator 400G, and allows the imaging apparatus 710 to capture an image of the patterned light containing the pattern F and derived from the infrared light IL enlarged and projected onto the screen SCR, and adjust the arrangement of the entire optical system including the projection system 600, the conditions under which the entire optical system operates, and other factors thereof with high accuracy.

The optical instrument including the optical element 521 according to the first embodiment is not limited to the projector 11, and may, for example, be a head mounted display and a head-up display.

### Second Embodiment

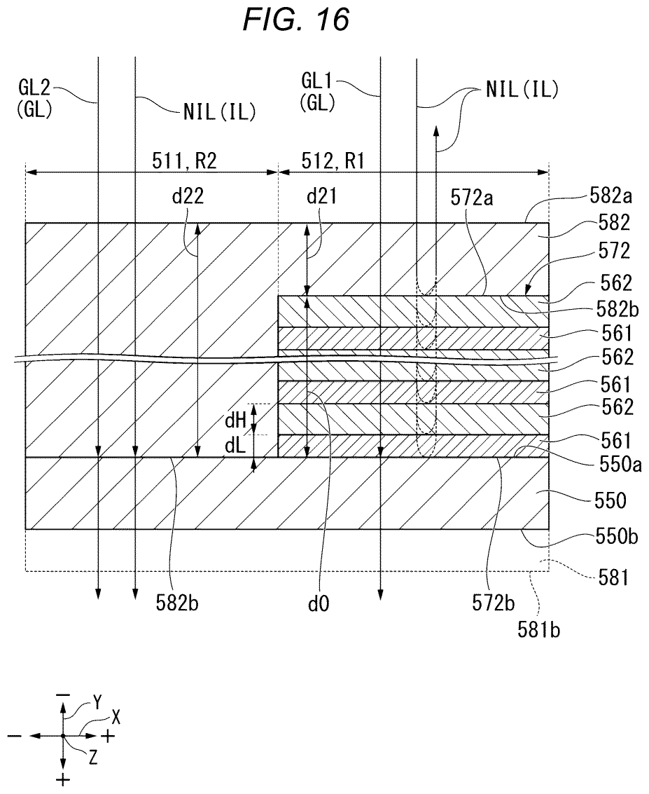

A second embodiment of the present disclosure will next be described with reference to FIGS. 16 to 18. Note in the second embodiment and a third embodiment that elements common to those in the first embodiment have reference characters that are the same as those of the corresponding elements in the first embodiment, and no descriptions redundant to those in the first embodiment will be made. In the second and third embodiments, elements, effects, advantages, and variations different from those in the first embodiment will be described.

### Projector

Although not shown, a projector according to the second embodiment is configured in the same manner as the projector 11 according to the first embodiment, and includes an optical element according to the second embodiment described below in place of the optical element 521.

### Optical Element

FIG. 16 is a cross-sectional view of key portions of the optical element according to the second embodiment, and corresponds to a cross-sectional view taken along the line III-III shown in FIG. 2. The optical element according to the second embodiment is configured with the substrate 550, a multilayer film 572, and an optical layer 582, as shown in FIG. 16.

The multilayer film 572 is formed at the plate surface 550a of the substrate 550 in the first region R1. That is, the multilayer film 572 is in contact with the substrate 550 on the −Y side. The multilayer film 572 corresponds to a first optical layer described later, and corresponds to the first optical layer described in the claims. A −Y-side surface 572a of the multilayer film 572 corresponds to a second surface described later, and corresponds to the second surface described in the claims. The multilayer film 572 transmits the green light GL incident from the −Y side along the Y-axis and emits the green light GL toward the +Y side, and reflects the infrared light IL incident from the −Y side along the Y-axis and emits the infrared light IL toward the −Y side, as the multilayer film 571.

The multilayer film 572 is a dielectric multilayer film configured with the low refractive index layers 561 and the high refractive index layers 562, as the multilayer film 571. The thickness dL and the refractive index nL of each of the low refractive index layers 561, the thickness dH and the refractive index nH of each of the high refractive index layers 562, and the total number of the refractive index layers of the multilayer film 572 in the optical element according to the second embodiment differ from those of the multilayer film 571 in the optical element 521 according to the first embodiment. For example, a high refractive index layer 562 is disposed on the side closest to the −Y side of the multilayer film 572, and a low refractive index layer 561 is disposed on the side closest to the +Y side of the multilayer film 572.

The optical layer 582 is formed at the −Y-side surface 572a of the multilayer film 572 in the first region R1 and the plate surface 550a of the substrate 550 in the second region R2. The optical layer 582 in the first region R1 and the optical layer 582 in the second region R2 have refractive indices comparable to each other and are made of the same material. The optical layer 582 corresponds to a medium described later and corresponds to the medium described in the claims. A −Y-side surface 582a of the optical layer 582 corresponds to a fourth surface described later, and corresponds to the fourth surface described in the claims. A +Y-side surface 582b of the optical layer 582 corresponds to a fifth surface described later, and corresponds to the fifth surface described in the claims.

The −Y-side surface 582a of the optical layer 582 in the first region R1 and the −Y-side surface 582a of the optical layer 582 in the second region R2 form a common planar surface and are parallel to a plane containing the X-axis and the Z-axis. A thickness d22 of the optical layer 582 in the second region R2, that is, the size of the optical layer 582 along the Y-axis in the second region R2 is the sum of the thickness d0 of the multilayer film 572 and the thickness d21 of the optical layer 582 in the first region R1.

The material of the optical layer 582 is a material that transmits at least the green light GL and the infrared light IL and is selected in accordance with an appropriately set refractive index as will be described later, and is preferably an organic filler or adhesive or an inorganic filler or adhesive that can be effective when irradiated with ultraviolet light or heat. The material of the optical layer 582 is, for example, an ultraviolet curable organic adhesive.

The refractive index of the optical layer 582 at the center wavelength of the green light GL is at least greater than 1.0. The material of the optical layer 582 preferably has a refractive index close to a refractive index nB of the substrate 550 at the center wavelength of the green light GL, and is specifically greater than or equal to nB−0.1 but smaller than or equal to nB+0.1. Since the refractive index of the optical layer 582 is comparable to the refractive index of the substrate 550, reflection of the green light GL and the infrared light IL side off the interface between the optical layer 582 and the substrate 550 in the second region R2 toward the −Y is suppressed.

In the optical element according to the second embodiment, an optical layer 581 may be formed at the +Y-side plate surface 550b of the substrate 550 in the first region R1 and the second region R2. The material of the optical layer 581 is a material that transmits at least the green light GL and the infrared light IL and is selected in accordance with an appropriately set refractive index as will be described later, and is preferably an organic filler or adhesive or an inorganic filler or adhesive that can be effective when irradiated with ultraviolet light or heat. The material of the optical layer 581 is, for example, the same as that of the optical layer 582.

A multilayer film that is not shown but is configured with high refractive index layers and low refractive index layers may be formed at the surface 582a of the optical layer 582, as in the case of the multilayer film 522 described in the first embodiment. In addition, a multilayer film that is not shown but is configured with high refractive index layers and low refractive index layers may be formed at the +Y-side plate surface 550b of the substrate 550 or a +Y-side surface 581b of the optical layer 581, as the multilayer film 522. These multilayer films each act as an antireflection film as the multilayer film 522, and contribute to improvement in planarity of the optical element according to the second embodiment.

As another variation, a transparent substrate with an antireflection film may be disposed, although not shown, at the surface 582a of the optical layer 582 and the +Y-side plate surface 550b of the substrate 550.

In the optical element according to the second embodiment, the effective refractive index and thickness d0 of the multilayer film 572, which are the difference in the optical configuration between the first region R1 and the second region R2, are so set that the phase difference OG between the green light GL1 and the green light GL2 is greater than or equal to −90° but smaller than or equal to 90°, and that the infrared light IL incident on the first region R1 is reflected toward the −Y side and therefore blocked. In detail, the refractive index nL and the thickness dL of each of the low refractive index layers 561, the refractive index nH and the thickness dH of each of the high refractive index layers 562, and the total number of the refractive index layers in the multilayer film 572 are so set that the phase difference OG between the green light GL1 and the green light GL2 is greater than or equal to −90° but smaller than or equal to 90° and the infrared light IL incident on the first region R1 is blocked.

In the optical element according to the second embodiment, the refractive index nL and the thickness dL of each of the low refractive index layers 561, the refractive index nH and the thickness dH of each of the high refractive index layers 562, and the total number of the refractive index layers in the multilayer film 572 are so set that the optical path length difference ΔOP between the green light GL1 and the green light GL2 is greater than or equal to (k−0.1) times but smaller than or equal to (k+0.1) times the reference wavelength of the green light GL.

### Design Examples of Optical Element

A design example <3> of the multilayer film 572 in consideration of the behaviors of the green light GL and the infrared light IL in the optical element according to the second embodiment will next be described. Table 3 shows the layer number of a refractive index layer counted from the +Y side, the material of the refractive index layer, and the thickness dL or dH of the refractive index layer in the first region R1 in the multilayer film 572 of the optical element according to the second embodiment.

TABLE 3

| | |
|---|---|
| Layer | Thickness [nm] |

| number | Material | R2 | R1 |
|---|---|---|---|
| 1 | SiO₂ | — | 50.0 |
| 2 | Nb₂O₅ | — | 101.6 |
| 3 | SiO₂ | — | 143.2 |
| 4 | Nb₂O₅ | — | 102.5 |
| 5 | SiO₂ | — | 175.9 |
| 6 | Nb₂O₅ | — | 102.1 |
| 7 | SiO₂ | — | 150.2 |
| 8 | Nb₂O₅ | — | 102.0 |
| 9 | SiO₂ | — | 176.0 |
| 10 | Nb₂O₅ | — | 102.7 |
| 11 | SiO₂ | — | 143.3 |
| 12 | Nb₂O₅ | — | 101.6 |

In the design example <3>, the material of the low refractive index layers 561 of the multilayer film 572 is SiO₂, and the material of the high refractive index layers 562 of the multilayer film 572 is Nb₂O₅, as shown in Table 3. In the design example <3>, the material of the optical layer 582 is an ultraviolet curable organic adhesive having a refractive index comparable to that of SiO₂ after cured by ultraviolet irradiation. The refractive index of the optical layer 582 at the center wavelength of the green light GL in the design example <3> is 1.47.

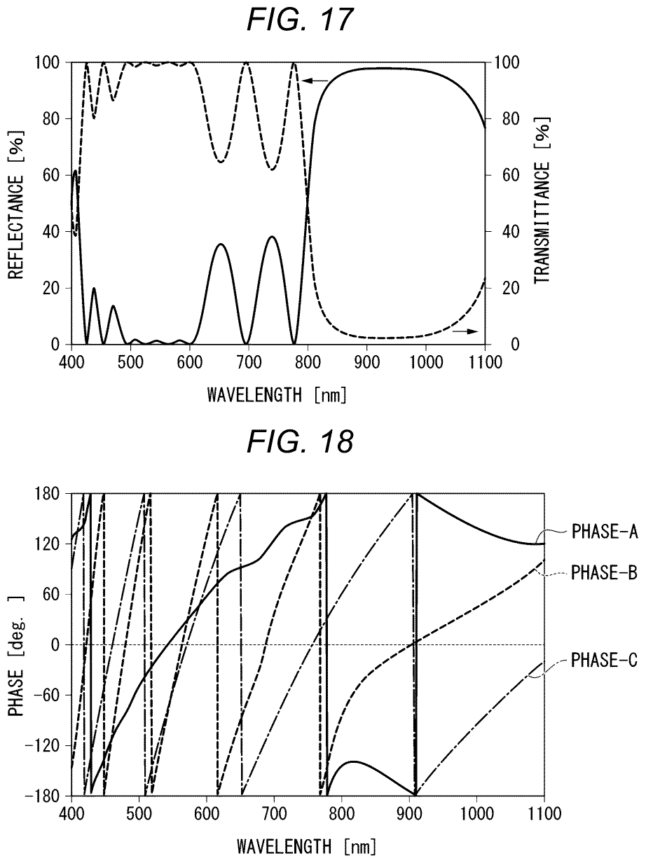

FIG. 17 shows graphs representing the wavelength dependence of the reflectance and transmittance of the first region R1, on which the light is incident from the −Y side along the Y-axis, in the design example <3> of the optical element 521. In FIG. 17, the horizontal axis represents the wavelength of the light incident on the first region R1. In FIG. 17, the vertical axis represents the reflectance of the first region R1, which reflects the light toward the −Y side, and the transmittance of the first region R1, on which the light is incident, at each wavelength of the light.

In the design example <3>, when the wavelength band of the light incident on the first region R1 is longer than or equal to 500 nm but shorter than or equal to 600 nm, the reflectance of the first region R1 that reflects the light is suppressed to a value higher than or equal to 0% but lower than or equal to 3%, as shown in FIG. 17. Therefore, the green light GL reflected off the first region R1 in the design example <3> of the optical element according to the second embodiment is very weak, and the observer is unlikely to visually recognize the pattern in the image light enlarged and projected onto the screen SCR for the projector according to the second embodiment. When the wavelength band of the light incident on the first region R1 is longer than or equal to 900 nm but shorter than or equal to 1000 nm, the reflectance of the first region R1 that reflects the light is higher than or equal to 978 but lower than or equal to 99%.

From the results described above, it is understood that when the green light GL having a uniform illuminance distribution in a plane containing the X-axis and the Z-axis enters the optical element of the design example <3> from the −Y side along the Y-axis, the green light GL having a uniform illuminance distribution in the plane containing the X-axis and the Z-axis is emitted toward the +Y side as in the case of the incidence of the light. It is understood that when the infrared light IL having a uniform illuminance distribution in a plane containing the X-axis and the Z-axis enters the optical element of the design example <3> from the −Y side along the Y-axis, the infrared light IL having an illuminance distribution containing the pattern F is emitted toward the +Y side.

In the design example <3>, the optical path length difference ΔOP between the two types of green light GL at the center wavelength of 550 nm thereof depends on the optical path length of the green light GL from the first low refractive index layer 561 to the twelfth high refractive index layer 562 of the multilayer film 572 in the first region R1. The optical path length of the green light GL1 in the first region R1 is expressed by {(refractive index nL of SiO₂ at 550 nm; 1.47)×(total thickness dL of SiO₂ in multilayer film 572; 838.60 nm)}+{(refractive index nH of Nb₂O₅ at 550 nm; 2.37)×(total thickness dH of Nb₂O₅ in multilayer film 572; 612.50 nm)}, and is 2684.37 nm. The optical path length of the green light GL2 in the second region R2 is expressed by (refractive index of organic adhesive at 550 nm; 1.47)×(thickness d0 of multilayer film 572; 1451.10 nm) and is 2133.12 nm.

The optical path length difference ΔOP at the center wavelength of 550 nm of the green light GL is 551.25 nm, corresponds to the (551.25/550) wavelengths, and corresponds to a shift of 1.00 wavelengths, that is, about one wavelength.

FIG. 18 shows graphs representing the wavelength dependence of the phase of the light incident on and passing through the first region R1 and the second region R2 from the −Y side along the Y-axis in the design example <3> of the optical element according to the second embodiment. In FIG. 18, the horizontal axis represents the wavelength of the light incident on the first region R1 and the second region R2. In FIG. 18, the vertical axis represents the phase of the light incident on and passing through the first region R1 and the second region R2 toward the +Y side at each wavelength of the light. The graph labeled with PHASE-A in FIG. 18 represents the phase difference between the phase of the light incident on and passing through the first region R1 and the phase of the light incident on and passing through the second region R2. The graph labeled with PHASE-B in FIG. 18 represents the phase of the light incident on and passing through the first region R1. The graph labeled with PHASE-C in FIG. 18 represents the phase of the light incident on and passing through the second region R2.

PHASE-A changes in accordance with the relative relationship between PHASE-B and PHASE-C together with the wavelength of the light incident on the first region R1 and the second region R2 of the optical element according to the second embodiment, as shown in FIG. 18. In the wavelength band of the green light GL ranging from 500 nm to 600 nm, PHASE-A increases from about −90.00° to about +80.00° as the wavelength increases. At the center wavelength of the green light GL, PHASE-A is about 10°.

In the design example <3>, the phase difference OG at the center wavelength of 550 nm of the green light GL is expressed by {remainder of (1.00/1.00)}×360°, and is 0°. The phase difference OG between the two types of green light GL, which belong to the wavelength band longer than or equal to 500 nm but shorter than or equal to 600 nm, ranges from −60.00° to 55.00°.

According to the aforementioned design of the multilayer film 572, when the green light GL is incident on the optical element according to the second embodiment from the −Y side along the Y-axis, and even when the green light GL1 and the green light GL2 are scattered or diffracted at the circumferential edge of the multilayer film 572 in the second region R2, the phase difference φG is greater than or equal to −90° but smaller than or equal to 90° and is 0°, so that the situation in which the green light GL1 and the green light GL2 weaken each other can be suppressed as much as possible, the illuminance unevenness of the green light GL emitted from the optical element according to the second embodiment toward the +Y side in a plane containing the X-axis and the Z-axis can be reduced to a smallest possible degree, and the generation of the pattern in the green light GL in accordance with the predetermined pattern F can be reduced to a smallest possible degree. When the infrared light IL is incident on the optical element according to the second embodiment from the −Y side along the Y-axis, the infrared light IL is favorably blocked by the multilayer film 572 in the second region R2, so that the infrared light IL emitted from the optical element according to the second embodiment toward the +Y side can contain a clear pattern formed in the plane containing the X-axis and the Z-axis.

### Method for Producing Optical Element

A method for producing the optical element according to the second embodiment will next be described. As the method for producing the optical element according to the second embodiment, for example, a production method 5 using the lift-off technology, and a production method 6 using the etching technology will be briefly described.

### Production Method 5

A photoresist is first applied to the plate surface 550a of the substrate 550 in the second region R2, and is exposed and developed. The multilayer film 572 is subsequently deposited at the plate surface 550a of the substrate 550 in the first region R1 and the −Y-side surface of the photoresist in the second region R2. The photoresist in the second region R2 is then removed together with the multilayer film 572 on the −Y side to expose the plate surface 550a of the substrate 550 in the second region R2.

The material of the optical layer 582 is next applied to the surface 572a of the multilayer film 572 in the first region R1 and the plate surface 550a of the substrate 550 in the second region R2 by using a method suitable for the material of the optical layer 582 to planarize the −Y-side surface of the resultant structure. Subsequently, the material of the optical layer 582 is cured by radiation of ultraviolet rays, heat, or the like that is suitable for the material of the optical layer 582 to form the optical layer 582 having the thickness d21 in the first region R1, and form the optical layer 582 having the thickness d22 in the second region R2.

The optical element according to the second embodiment is produced by the steps described above. In the production method 5, patterning and photolithography are performed once, and film deposition is performed once.

### Production Method 6

The multilayer film 572 is first deposited at the plate surface 550a of the substrate 550 in the first region R1 and the second region R2. A photoresist is next applied only to the surface 572a of the multilayer film 572 in the first region R1, and is exposed and developed. The multilayer film 572 in the second region R2 is subsequently removed, for example, by dry etching using the photoresist as a mask. Furthermore, the photoresist in the first region R1 is removed to expose the surface 572a of the multilayer film 572 in the first region R1 and the plate surface 550a of the substrate 550 in the second region R2.

The material of the optical layer 582 is next applied to the surface 572a of the multilayer film 572 in the first region R1 and the plate surface 550a of the substrate 550 in the second region R2 by using a method suitable for the material of the optical layer 582 to planarize the −Y-side surface of the resultant structure. Subsequently, the material of the optical layer 582 is cured by radiation of ultraviolet rays, heat, or the like that is suitable for the material of the optical layer 582 to form the optical layer 582 having the thickness d21 in the first region R1, and form the optical layer 582 having the thickness d22 in the second region R2.

The optical element according to the second embodiment is produced by the steps described above. In the production method 6, patterning and photolithography are performed once, film deposition is performed once, and etching is performed once.

### Other Steps

When a multilayer film that is not shown is disposed at the surface 582a of the optical layer 582 and the +Y-side plate surface 550b of the substrate 550, a multilayer film that is not show but is similar to the multilayer film 522 is deposited at the surface 582a of the optical layer 582 and the +Y-side plate surface 550b of the substrate 550 after the production method 5 or 6 described above.

When a transparent substrate with an antireflection film, although not shown, is disposed at the surface 582a of the optical layer 582 and the +Y-side plate surface 550b of the substrate 550, the transparent substrate with an antireflection film, although not shown, is bonded to the surface 582a of the optical layer 582 and the +Y-side plate surface 550b of the substrate 550 with a transparent adhesive that is not shown or the like after the production method 5 or 6 described above. Thereafter, a multilayer film that is not shown but is similar to the multilayer film 522 may be deposited at the −Y-side plate surface of the transparent substrate having an antireflection film that has been disposed at the surface 582a of the optical layer 582. The multilayer film, which is not shown but is similar to the multilayer film 522, may be deposited at the −Y-side plate surface of the transparent substrate having an antireflection film that has been disposed at the plate surface 550b of the substrate 550.

According to the production method 5 or 6, the optical element according to the second embodiment, and an optical element providing the same effects and advantages provided by the optical element according to the second embodiment t can be readily produced at low cost through patterning and photolithography performed once.

### SUMMARY

The optical element according to the second embodiment described above includes the substrate 550 and the multilayer film (first optical layer) 572. The multilayer film 572 is disposed in the first region R1 at the plate surface 550a of the substrate 550. In the optical element according to the second embodiment, the refractive index and the thickness of the multilayer film 572 are determined, for example, by the refractive index nL and the thickness dL of each of the low refractive index layers 561, which constitute the multilayer film 572, and the refractive index nH and the thickness dH of each of the high refractive index layers 562, which constitute the multilayer film 572. The refractive index nL and the thickness dL of each of the low refractive index layers 561, and the refractive index nH and the thickness dH of each of the high refractive index layers 562 are so set that the phase difference OG between the green light GL1 and the green light GL2 is greater than or equal to −90° but smaller than or equal to 90° and the infrared light IL incident on the first region R1 is blocked.

In the optical element according to the second embodiment, the green light GL1 is incident on the first region R1 from the −Y side along the Y-axis, and the green light GL2 is incident on the second region R2 from the −Y side along the Y-axis, and very small part of the green light GL1 and GL2 is scattered or diffracted at the circumferential edge of the multilayer film 572. The optical element according to the second embodiment, in which the phase difference OG is greater than or equal to −90° but smaller than or equal to 90°, can suppress the situation in which the green light GL1 and the green light GL2 scattered or diffracted at the circumferential edge of the multilayer film 572 weaken each other, can suppress occurrence of illuminance unevenness of the green light GL, and prevent the green light GL that does not originally generate patterned light from generating patterned light containing the pattern F′. The optical element according to the second embodiment, in which the infrared light IL is incident on the first region R1 and the second region R2 from the −Y side along the Y-axis, and the infrared light IL incident on the first region R1 is reflected off the multilayer film 572 toward the −Y side and therefore blocked on the +Y side, allows even the infrared light IL to favorably generate patterned light containing the pattern F.

The optical element according to the second embodiment further includes the optical layer (medium) 582. The optical layer 582 is disposed on the −Y side of the multilayer film 572, that is, the surface (second surface) 572a, on which the green light GL and the infrared light IL are incident, and the plate surface 550a of the substrate 550 in the second region R2. The refractive index of the optical layer 582 is at least greater than 1.0, for example, 1.47. In the first region R1, the −Y side of the optical layer 582, that is, the +Y-side surface (fifth surface) 572b opposite the surface (fourth surface) 572a, on which the green light GL and the infrared light IL are incident, is in contact with the −Y-side plate surface (first surface) 550a of the substrate 550. In the second region R2, the surface 572b of the multilayer film 572 is in contact with the −Y-side plate surface (first surface) 550a of the substrate 550. In the optical element according to the second embodiment, the thickness d22 of the optical layer 582 in the second region R2 differs from the thickness d21 of the optical layer 582 in the first region R1.

In the optical element according to the second embodiment, since the green light GL and the infrared light IL incident from the −Y side along the Y-axis in the first region R1 and the green light GL and the infrared light IL incident from the −Y side along the Y-axis in the second region R2 enter the common optical layer 582, the refractive index condition at the time of incidence of the green light GL and the infrared light IL from the −Y side can be the same in the first region R1 and the second region R2, so that the occurrence of the illuminance unevenness of the green light GL can be suppressed. In the optical element according to the second embodiment, the fact that the thickness d22 of the optical layer 582 in the second region R2 is made greater than the thickness d21 of the optical layer 582 in the first region R1 in consideration of the thickness d0 of the multilayer film 572 allows suppression of the difference in physical thickness between the first region R1 and the second region, so that the optical element is readily handed. In the optical element according to the second embodiment, setting the thicknesses d21 and d22 in a way that the surface 582a of the optical layer 582 in the first region R1 and the surface 582a of the optical layer 582 in the second region R2 form a single planar surface allows the entire optical element to be planar, as compared with the optical element 521 according to the first embodiment.

In the optical element according to the second embodiment, the refractive index of the optical layer 582 at the center wavelength of the green light GL is comparable to the refractive index nB of the substrate 550 at the center wavelength of the green light GL, and is greater than or equal to nB−0.1 but smaller than or equal to nB+0.1.

The optical element according to the second embodiment can suppress reflection of the green light GL off the −Y-side plate surface 550a of the substrate 550 in the second region R2, suppress occurrence of beam deviation of the light incident on the optical element according to the second embodiment due to dimensional errors in the production of the optical element, and suppress the amount of the beam deviation.

In the optical element according to the second embodiment, the multilayer film 572 is configured with a dielectric multilayer film including the high refractive index layers 562 and the low refractive index layers 561.

In the optical element according to the second embodiment, in which the multilayer film 572 is configured with the dielectric multilayer film, the refractive index nL and the thickness dL of each of the low refractive index layers 561 and the refractive index nH and the thickness dH of each of the high refractive index layers 562 can be flexibly adjusted in a way that the phase difference OG between the green light GL1 and the green light GL2 is greater than or equal to −90° but smaller than or equal to 90° or the optical path length difference ΔOP is greater than or equal to (k−0.1) times but smaller than or equal to (k+0.1) times the reference wavelength of the green light GL, so that the effective refractive index and thickness d0 of the multilayer film 572 can be appropriately set. The optical element according to the second embodiment allows a widened range e from which the material of each of the low refractive index layers 561 and the high refractive index layers 562 of the multilayer film 572 is selected.

In the optical element according to the second embodiment, the refractive index of the optical layer 582 at the center wavelength of the green light GL is comparable to the refractive index nL of the low refractive index layers 561 of the multilayer film 572.

The optical element according to the second embodiment allows a widened range from which the material of the optical layer 582 is selected, so that the optical element can be readily produced. In the optical element according to the second embodiment, the optical path length of the green light GL in the second region R2 is prolonged, so that suppressing illuminance unevenness of the green light GL emitted toward the +Y side and blocking the infrared light IL in the second region R2 can both be readily achieved, as compared with the optical element 521 according to the first embodiment.

As a variation of the optical element according to the second embodiment, note that the refractive index of the optical layers 582 at the center wavelength of the green light GL may be comparable to the refractive index nH of the high refractive index layers 562 of the multilayer film 572. Also in this case, the optical path length of the green light GL in the second region R2 is prolonged, so that suppressing illuminance unevenness of the green light GL emitted toward the +Y side and blocking the infrared light IL in the second region R2 can both be readily achieved, as compared with the optical element 521 according to the first embodiment.

The projector (optical instrument) according to the second embodiment includes the optical element according to the second embodiment. Specifically, in the projector according to the second embodiment, the optical element according to the second embodiment is disposed closer to the −Y side than the light modulator 400G, that is, on a side of the light modulator 400G that is the side on which the green light GL and the infrared light IL are incident.

The projector according to the second embodiment can suppress the generation of the pattern F′ in the image light enlarged and projected onto the screen SCR from the projection system 600, and allows the imaging apparatus 710 to capture an image of the patterned light containing the pattern F and derived from the infrared light IL enlarged and projected onto the screen SCR, and adjust the arrangement of the entire optical system including the projection system 600, the conditions under which the entire optical system operates, and other factors thereof with high accuracy, as the projector 11 according to the first embodiment.

### Third Embodiment

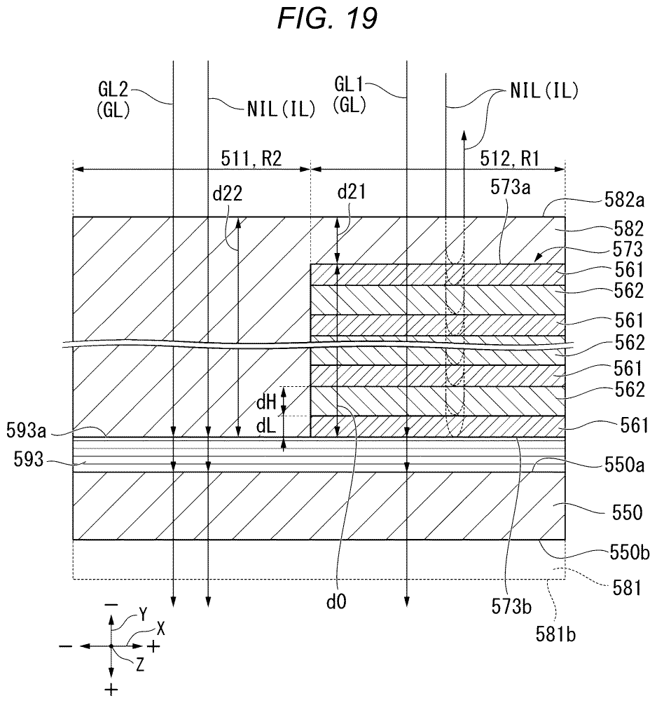

A third embodiment of the present disclosure will next be described with reference to FIGS. 19 to 21.

### Projector

Although not shown, a projector according to the third embodiment is configured in the same manner as the projector 11 according to the first embodiment, and includes an optical element according to the third embodiment described below in place of the optical element 521.

### Optical Element

FIG. 19 is a cross-sectional view of key portions of the optical element according to the third embodiment, and corresponds to a cross-sectional view taken along the line III-III shown in FIG. 2. The optical element according to the third embodiment is configured with the substrate 550, an optical film 593, a multilayer film 573, and the optical layer 582, as shown in FIG. 19.

The optical film 593 is formed at the plate surface 550a of the substrate 550 in the first region R1 and the second region R2, and is layered on the −Y side of the substrate 550.

The optical film 593 corresponds to an antireflection film described later, and corresponds to the antireflection film described in the claims.

The optical film 593 transmits all of the green light GL and the infrared light IL incident from the −Y side along the Y-axis, and causes the green light GL and the infrared light IL to enter the substrate 550 from the −Y side. The optical film 593 acts as an antireflection film for the substrate 550. The material of the optical film 593 is, for example, aluminum trioxide (Al₂O₃).

The multilayer film 573 is formed at a −Y-side surface 593a of the optical film 593 in the first region R1. The multilayer film 573 corresponds to a first optical layer described later, and corresponds to the first optical layer described in the claims. A −Y-side surface 573a of the multilayer film 573 corresponds to a second surface described later, and corresponds to the second surface described in the claims. The multilayer film 573 transmits the green light GL incident from the −Y side along the Y-axis and emits the green light GL toward the +Y side, and reflects the infrared light IL incident from the −Y side along the Y-axis and emits the infrared light IL toward the −Y side, as the multilayer films 571 and 572.

The multilayer film 573 is a dielectric multilayer film configured with the low refractive index layers 561 and the high refractive index layers 562, as the multilayer films 571 and 572. The thickness dL and the refractive index nL of each of the low refractive index layers 561, the thickness dH and the refractive index nH of each of the high refractive index layers 562, and the total number of the refractive index layers of the multilayer film 573 in the optical element according to the third embodiment differ from those of the multilayer film 571 in the optical element 521 according to the first embodiment, and also differ from those of the multilayer film 572 in the optical element according to the second embodiment.

The refractive index nH of the high refractive index layers 562 of the multilayer film 573 at the center wavelength of the green light GL is lower than the refractive index nH of the high refractive index layers 562 of the multilayer films 571 and 572. For example, a low refractive index layer 561 is disposed on the side closest to the −Y side of the multilayer film 573, and another low refractive index layer 561 is disposed on the side closest to the +Y side of the multilayer film 573. The material of the high refractive index layers 562 is selected in accordance with an appropriately set refractive index, as will be described later, and is preferably any of an oxide, a nitride, and a fluoride, for example, zirconium dioxide (ZrO₂).

The optical layer 582 is formed at the −Y-side surface 573a of the multilayer film 573 in the first region R1 and the plate surface 550a of the substrate 550 in the second region R2.

Also in the optical element according to the third embodiment, the optical layer 581 may be formed at the +Y-side plate surface 550b of the substrate 550 in the first region R1 and the second region R2. Also in the optical element according to the third embodiment, a multilayer film that is not shown but is configured with high refractive index layers and low refractive index layers may be formed at the surface 582a of the optical layer 582, as in the case of the multilayer film 522 described in the first embodiment. In addition, a multilayer film that is not shown but is configured with high refractive index layers and low refractive index layers may be formed at the +Y-side plate surface 550b of the substrate 550 or the +Y-side surface 581b of the optical layer 581, as the multilayer film 522. As another variation of the optical element according to third embodiment, a transparent substrate with an antireflection film may be disposed, although not shown, at the surface 582a of the optical layer 582 and the +Y-side plate surface 550b of the substrate 550.

In the optical element according to the third embodiment, the effective refractive index and thickness d0 of the multilayer film 573, which are the difference in the optical configuration between the first region R1 and the second region R2, are so set that the phase difference OG between the green light GL1 and the green light GL2 is greater than or equal to −90° but smaller than or equal to 90°, and that the infrared light IL incident on the first region R1 is reflected toward the −Y side and therefore blocked. In detail, the refractive index nL and the thickness dL of each of the low refractive index layers 561, the refractive index nH and the thickness dH of each of the high refractive index layers 562, and the total number of the refractive index layers in the multilayer film 573 are so set that the phase difference OG between the green light GL1 and the green light GL2 is greater than or equal to −90° but smaller than or equal to 90° and the infrared light IL incident on the first region R1 is blocked.

In the optical element according to the third embodiment, the refractive index nL and the thickness dL of each of the low refractive index layers 561, the refractive index nH and the thickness dH of each of the high refractive index layers 562, and the total number of the refractive index layers in the multilayer film 573 are so set that the optical path length difference ΔOP between the green light GL1 and the green light GL2 is greater than or equal to (k−0.1) times but smaller than or equal to (k+0.1) times the reference wavelength of the green light GL.

### Design Examples of Optical Element

A design example <4> of the multilayer film 573 in consideration of the behaviors of the green light GL and the infrared light IL in the optical element according to the third embodiment will next be described. Table 4 shows the material of the optical film 593, the thickness of the optical film 593 in the first and second regions, the layer number of a refractive index layer counted from the +Y side in the multilayer film 573, the material of the refractive index layer, and the thickness dL or dH of the refractive index layer in the first region R1 in the optical element according to the third embodiment.

TABLE 4

| | |
|---|---|
| Layer | Thickness [nm] |

| | number | Material | R2 | R1 |
|---|---|---|---|---|
| 593 | — | Al₂O₃ | 170.5 | 170.5 |
| 573 | 1 | SiO₂ | — | 137.4 |
| | 2 | ZrO₂ | — | 128.1 |
| | 3 | SiO₂ | — | 150.8 |
| | 4 | ZrO₂ | — | 125.0 |
| | 5 | SiO₂ | — | 155.4 |
| | 6 | ZrO₂ | — | 125.1 |
| | 7 | SiO₂ | — | 153.8 |
| | 8 | ZrO₂ | — | 124.0 |
| | 9 | SiO₂ | — | 156.0 |
| | 10 | ZrO₂ | — | 125.0 |
| | 11 | SiO₂ | — | 153.4 |
| | 12 | ZrO₂ | — | 124.0 |
| | 13 | SiO₂ | — | 157.3 |

In the design example <4>, the material of the optical film 593 is Al₂O₃, as shown in Table 4. The material of the low refractive index layers 561 of the multilayer film 573 is SiO₂, and the material of the high refractive index layers 562 of the multilayer film 573 is ZrO₂. In the design example <4>, the material of the optical layer 582 is an ultraviolet curable organic adhesive having a refractive index higher than that of SiO₂ after cured by ultraviolet irradiation. The refractive index of the optical layer 582 at the center wavelength of the green light GL in the design example <4> is 1.70.

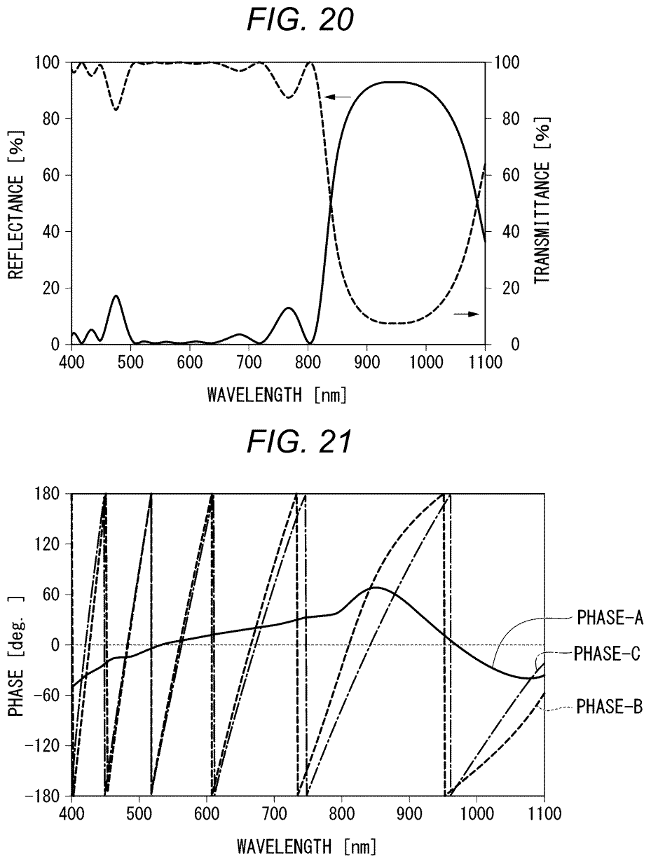

FIG. 20 shows graphs representing the wavelength dependence of the reflectance and transmittance of the first region R1, on which the light is incident from the −Y side along the Y-axis, in the design example <4> of the optical element according to the third embodiment. In FIG. 20, the horizontal axis represents the wavelength of the light incident on the first region R1. In FIG. 20, the vertical axis represents the reflectance of the first region R1, which reflects the light toward the −Y side, and the transmittance of the first region R1, on which the light is incident, at each wavelength of the light.

In the design example <4>, when the wavelength band of the light incident on the first region R1 is longer than or equal to 500 nm but shorter than or equal to 600 nm, the reflectance of the first region R1 that reflects the light is suppressed to a value higher than or equal to 0% but lower than or equal to 2%, as shown in FIG. 20. Therefore, the green light GL reflected off the first region R1 in the design example <4> of the optical element according to the third embodiment is very weak, and the observer is unlikely to visually recognize the pattern in the image light enlarged and projected onto the screen SCR for the projector according to the third embodiment. When the wavelength band of the light incident on the first region R1 is longer than or equal to 900 nm but shorter than or equal to 1000 nm, the reflectance of the first region R1 that reflects the light is higher than or equal to 90% but lower than or equal to 94%.

From the results described above, it is understood that when the green light GL having a uniform illuminance distribution in a plane containing the X-axis and the Z-axis enters the optical element of the design example <4> from the −Y side along the Y-axis, the green light GL having a uniform illuminance distribution in the plane containing the X-axis and the Z-axis is emitted toward the +Y side as in the case of the incidence of the light. It is understood that when the infrared light IL having a uniform illuminance distribution in a plane containing the X-axis and the Z-axis enters the optical element of the design example <4> from the −Y side along the Y-axis, the infrared light IL having an illuminance distribution containing the pattern F is emitted toward the +Y side.

In the design example <4>, the optical path length difference ΔOP between the two types of green light GL at the center wavelength of 550 nm thereof depends on the optical path length of the green light GL from the first low refractive index layer 561 to the thirteenth low refractive index layer 561 of the multilayer film 572 in the first region R1. The optical path length of the green light GL in the first region R1 is expressed by {(refractive index nL of SiO₂ at 550 nm; 1.47)×(total thickness dL of SiO₂ in multilayer film 573; 1064.10 nm)}+{(refractive index nH of ZrO₂ at 550 nm; 2.02)×(total thickness dH of ZrO₂ in multilayer film 573; 751.20 nm)}, and is 3081.65 nm. The optical path length of the green light GL in the second region R2 is expressed by (refractive index of organic adhesive at 550 nm; 1.70)×(thickness d0 of multilayer film 573; 1815.30 nm) and is 3086.01 nm.

The optical path length difference ΔOP at the center wavelength of 550 nm of the green light GL is 4.36 nm, corresponds to the (4.36/550) wavelengths, and corresponds to a shift of 0.01 wavelengths, that is, about zero wavelength.

FIG. 21 shows graphs representing the wavelength dependence of the phase of the light incident on and passing through the first region R1 and the second region R2 from the −Y side along the Y-axis in the design example <4> of the optical element according to the third embodiment. In FIG. 21, the horizontal axis represents the wavelength of the light incident on the first region R1 and the second region R2. In FIG. 21, the vertical axis represents the phase of the light incident on and passing through the first region R1 and the second region R2 toward the +Y side at each wavelength of the light. The graph labeled with PHASE-A in FIG. 21 represents the phase difference between the phase of the light incident on and passing through the first region R1 and the phase of the light incident on and passing through the second region R2. The graph labeled with PHASE-B in FIG. 21 represents the phase of the light incident on and passing through the first region R1. The graph labeled with PHASE-C in FIG. 21 represents the phase of the light incident on and passing through the second region R2.

PHASE-A changes in accordance with the relative relationship between PHASE-B and PHASE-C together with the wavelength of the light incident on the first region R1 and the second region R2 of the optical element according to the third embodiment, as shown in FIG. 21. In the wavelength band of the green light GL from 500 nm to 600 nm, as the wavelength increases from 500 nm to 535 nm, PHASE-A increases from about 120.00° to +180.00°, and temporarily becomes comparable to −180.00°. As the wavelength increases from 535 nm to 600 nm, PHASE-A changes from −180.00° to about 170.00°. At the center wavelength of the green light GL, PHASE-A is about −10°.

In the design example <4>, the phase difference OG at the center wavelength of 550 nm of the green light GL is expressed by {remainder of (0.01/1.00)}×360°, and is 3.6°. The phase difference OG between the two types of green light GL, which belong to the wavelength band longer than or equal to 500 nm but shorter than or equal to 600 nm, ranges from 120.00° to 180.00° and −180.00° to 140.00°.

According to the aforementioned design of the multilayer film 573 in consideration of the refractive index and the like of the optical layer 582, when the green light GL is incident on the optical element according to the third embodiment from the −Y side along the Y-axis, and even when the green light GL1 and the green light GL2 are scattered or diffracted at the circumferential edge of the multilayer film 573 in the second region R2, the phase difference φG is greater than or equal to −90° but smaller than or equal to 90° and is 0°, so that the situation in which the green light GL1 and the green light GL2 weaken each other can be suppressed as much as possible, the illuminance unevenness of the green light GL emitted from the optical element according to the third embodiment toward the +Y side in a plane containing the X-axis and the Z-axis can be reduced to a smallest possible degree, and the generation of the pattern in the green light GL in accordance with the predetermined pattern F can be reduced to a smallest possible degree. When the infrared light IL is incident on the optical element according to the third embodiment from the −Y side along the Y-axis, the infrared light IL is favorably blocked by the multilayer film 573 in the second region R2, so that the infrared light IL emitted from the optical element according to the third embodiment toward the +Y side can contain a clear pattern formed in the plane containing the X-axis and the Z-axis.

### Method for Producing Optical Element

A method for producing the optical element according to the third embodiment will next be described. The optical element according to the third embodiment can be produced in the same manner by the production method 5 using the lift-off technology or the production method 6 using the etching technology described in the second embodiment.

In the production of the optical element according to the third embodiment, for example, in the production method 5, the optical film 593 is deposited at the plate surface 550a of the substrate 550 in the first region R1 and the second region R2 before a photoresist is applied to the plate surface 550a of the substrate 550 in the second region R2. A photoresist is subsequently applied to the optical film 593 in the second region R2, and is exposed and developed. The multilayer film 573 is then deposited at the surface 593a of the optical film 593 in the first region R1 and the −Y-side surface of the photoresist in the second region R2.

The photoresist in the second region R2 is next removed together with the multilayer film 573 on the −Y side to expose the surface 593a of the optical film 593 in the second region R2. The material of the optical layer 582 is subsequently applied to the surface 573a of the multilayer film 573 in the first region R1 and the surface 593a of the optical film 593 in the second region R2 by using a method suitable for the material of the optical layer 582 to planarize the −Y-side surface of the resultant structure. Subsequently, the material of the optical layer 582 is cured by radiation of ultraviolet rays, heat, or the like that is suitable for the material of the optical layer 582 to form the optical layer 582 having the thickness d21 in the first region R1, and form the optical layer 582 having the thickness d22 in the second region R2.

The optical element according to the third embodiment is produced by the steps described above. In the method for producing the optical element according to the third embodiment described above, patterning and photolithography are performed once, and film deposition is performed twice.

In the production of the optical element according to the third embodiment, for example, in the production method 6, the optical film 593 is deposited at the plate surface 550a of the substrate 550 in the first region R1 and the second region R2 before the multilayer film 573 is deposited at the plate surface 550a of the substrate 550 in the first region R1 and the second region R2. The multilayer film 573 is subsequently deposited at the surface 593a of the optical film 593 in the first region R1 and the second region R2. A photoresist is then applied only to the surface 573a of the multilayer film 573 in the first region R1, and is exposed and developed. The multilayer film 573 in the second region R2 is subsequently removed, for example, by dry etching using the photoresist as a mask. The photoresist in the first region R1 is removed to expose the surface 573a of the multilayer film 573 in the first region R1 and the surface 593a of the optical film 593 in the second region R2.

The material of the optical layer 582 is next applied to the surface 573a of the multilayer film 573 in the first region R1 and the plate surface 550a of the substrate 550 in the second region R2 by using a method suitable for the material of the optical layer 582 to planarize the −Y-side surface of the resultant structure. Subsequently, the material of the optical layer 582 is cured by radiation of ultraviolet rays, heat, or the like that is suitable for the material of the optical layer 582 to form the optical layer 582 having the thickness d21 in the first region R1, and form the optical layer 582 having the thickness d22 in the second region R2.

The optical element according to the third embodiment is produced by the steps described above. In the method for producing the optical element according to the third embodiment described above, patterning and photolithography are performed once, film deposition is performed twice, and etching is performed once.

### Other Steps

In the production of the optical element according to the third embodiment, the same other steps described in the second embodiment may be performed.

### SUMMARY

The optical element according to the third embodiment described above includes the substrate 550 and the multilayer film (first optical layer) 573. The multilayer film 573 is disposed in the first region R1 at the plate surface 550a of the substrate 550 via the optical film 593. In the optical element according to the third embodiment, the refractive index and the thickness of the multilayer film 573 are determined, for example, by the refractive index nL and the thickness dL of each of the low refractive index layers 561, which constitute the multilayer film 573, and the refractive index nH and the thickness dH of each of the high refractive index layers 562, which constitute the multilayer film 573. The refractive index nL and the thickness dL of each of the low refractive index layers 561, and the refractive index nH and the thickness dH of each of the high refractive index layers 562 are so set that the phase difference φG between the green light GL1 and the green light GL2 is greater than or equal to −90° but smaller than or equal to 90° and the infrared light IL incident on the first region R1 is blocked.

In the optical element according to the third embodiment, the green light GL1 is incident on the first region R1 from the −Y side along the Y-axis, and the green light GL2 is incident on the second region R2 from the −Y side along the Y-axis, and very small part of the green light GL1 and GL2 is scattered or diffracted at the circumferential edge of the multilayer film 573. The optical element according to the third embodiment, in which the phase difference φG is greater than or equal to −90° but smaller than or equal to 90°, can suppress the situation in which the green light GL1 and the green light GL2 scattered or diffracted at the circumferential edge of the multilayer film 573 weaken each other, can suppress occurrence of illuminance unevenness of the green light GL, and prevent the green light GL that does not originally generate patterned light from generating patterned light containing the pattern F′. The optical element according to the third embodiment, in which the infrared light IL is incident on the first region R1 and the second region R2 from the −Y side along the Y-axis, and the infrared light IL incident on the first region R1 is reflected off the multilayer film 573 toward the −Y side and therefore blocked on the +Y side, allows even the infrared light IL to favorably generate patterned light containing the pattern F.

In the optical element according to the third embodiment, the refractive index of the optical layer 582 at the center wavelength of the green light GL differs from the refractive index nB of the substrate 550 at the center wavelength of the green light GL, and is, for example, greater than nB+0.1. The optical element according to the third embodiment further includes the optical film (antireflection film) 593. The optical film 593 is disposed between the substrate 550 and the multilayer film 573 in the first region R1 and between the substrate 550 and the optical layer 582 in the second region R2.

In the optical element according to the third embodiment, even when the material of the optical layer 582 has a refractive index higher than the refractive index nB of the substrate 550 as described above, the reflection of the green light GL off the plate surface 550a of the substrate 550 can be suppressed by the optical 593. An inexpensive SiO₂ substrate or the like can therefore be used as the substrate 550 irrespective of the material of the optical layer 582.

As a variation of the optical element according to the third embodiment, the refractive index of the optical layer 582 at the center wavelength of the green light GL may differ from the refractive index nB of the substrate 550 at the center wavelength of the green light GL, and is, for example, smaller than nB−0.1. Even when the material of the optical layer 582 has a refractive index lower than the refractive index nB of the substrate 550 as described above, the reflection of the green light GL off the plate surface 550a of the substrate 550 can be suppressed by the optical film 593, and the material of the substrate 550 can be selected from a widened range.

In the optical element according to the third embodiment, the multilayer film 573 is configured with a dielectric multilayer film including the high refractive index layers 562 and the low refractive index layers 561.

In the optical element according to the third embodiment, in which the multilayer film 573 is configured with the dielectric multilayer film, the refractive index nL and the thickness dL of each of the low refractive index layers 561 and the refractive index nH and the thickness dH of each of the high refractive index layers 562 can be flexibly adjusted in a way that the phase difference OG between the green light GL1 and the green light GL2 is greater than or equal to −90° but smaller than or equal to 90° or the optical path length difference ΔOP is greater than or equal to (k−0.1) times but smaller than or equal to (k+0.1) times the reference wavelength of the green light GL, so that the effective refractive index and thickness d0 of the multilayer film 573 can be appropriately set. The optical element according to the third embodiment allows a widened range from which the material of each of the low refractive index layers 561 and the high refractive index layers 562 of the multilayer film 573 is selected.

In the optical element according to the third embodiment, the refractive index of the optical layer 582 at the center wavelength of the green light GL is higher than the refractive index nL of the low refractive index layers 561 of the multilayer film 573 but lower than the refractive index nH of the high refractive index layers 562 of the multilayer film 573.

The optical element according to the third embodiment allows a widened range from which the material of the optical layer 582 is selected, so that the optical element can be readily produced. The optical element according to the third embodiment can readily bring the phase difference φG between the green light GL1 and the green light GL2 close to 0°, can suppress the situation in which the green light GL1 and the green light GL2 scattered or diffracted at the circumferential edge of the multilayer film 573 weaken each other, and can suppress occurrence of illuminance unevenness of the green light GL, as compared with the optical element according to the second embodiment.

A projector (optical instrument) according to the third embodiment includes the optical element according to the third embodiment. Specifically, in the projector according to the third embodiment, the optical element according to the third embodiment is disposed closer to the −Y side than the light modulator 400G, that is, on a side of the light modulator 400G that is the side on which the green light GL and the infrared light IL are incident.

The projector according to the third embodiment can suppress the generation of the pattern F′ in the image light enlarged and projected onto the screen SCR from the projection system 600, and allows the imaging apparatus 710 to capture an image of the patterned light containing the pattern F and derived from the infrared light IL enlarged and projected onto the screen SCR, and adjust the arrangement of the entire optical system including the projection system 600, the conditions under which the entire optical system operates, and other factors thereof with high accuracy, as the projector 11 according to the first embodiment.

Preferable embodiments of the present disclosure have been described above in detail. The present disclosure is, however, not limited to a specific embodiment, and various modifications and changes can be made thereto within the scope of the key points of the present disclosure described in the claims.

In the design examples <1>, <3>, and <4> relating to the embodiments described above, the optical path length difference ΔOP between the green light GL1 and the green light GL2 is 0 to about 2 times the center wavelength of the green light GL. When the wavelength width or the half width of the spectrum of the green light GL emitted from the light source apparatus 100 of the illuminator 20 is relatively narrow, the natural number k may be relatively large, and the same effects and advantages as those provided by the optical element according to any of the embodiments described above can be provided. For example, when the light source apparatus 100 uses an LED that emits the green light GL having a half width ranging from 30 nm to 50 nm, the natural number k may be about 4 or 5.

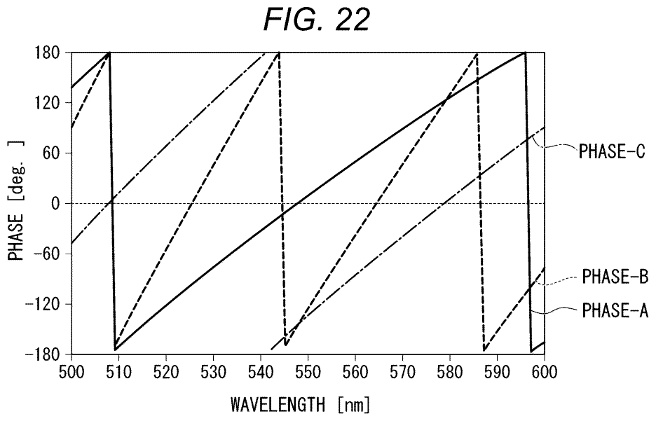

FIG. 22 shows graphs representing the wavelength dependence of the phase of the light incident on and passing through the first region R1 and the second region R2 from the −Y side along the Y-axis in a case where it is assumed that k=5 in the design example <1>, that is, the optical path length difference ΔOP corresponds to a shift of about five wavelengths. In this case, the thickness d0 of the multilayer film 571 is calculated to be 3372 nm. The phase difference OG between the green light GL1 and the green light GL2, that is, the phase difference OG at the wavelength of 550 nm is about 0°, but the phase difference OG between the two types of green light GL in the wavelength band longer than or equal to 500 nm but shorter than or equal to 600 nm greatly changes as compared with the case of k=2 described in the first embodiment.

When the width of the spectrum of the green light GL is narrow, and, for example, a range longer than or equal to 525 nm but shorter than or equal to 575 nm only needs to be considered, however, the range of the phase difference OG is greater than or equal to −90° but smaller than or equal to 90°, so that the same effects and advantages provided by the optical element according to the first embodiment are provided. For example, when a range longer than or equal to 535 nm but shorter than or equal to 565 nm only needs to be considered, the range of the phase difference OG can be reduced to a range greater than or equal to −45° but smaller than or equal to 60°, the situation in which the green light GL1 and the green light GL2 scattered or diffracted at the circumferential edge of the multilayer film 571 weaken each other can be further suppressed, and occurrence of illuminance unevenness of the green light GL can be further suppressed.

In the projector according to any of the embodiments described above, the optical elements is not necessarily disposed between the field lens 300G and the light modulator 400G in the optical path of the green light GL and the infrared light IL emitted from the dichroic mirror 220. As a variation of the projector according to any of the embodiments described above, for example, the reflection mirror 250 may be replaced with a dichroic mirror, and the optical element may be disposed between the field lens 300R and the light modulator 400R. In this case, the light source apparatus 150 is disposed closer to the +X side than the new dichroic mirror, and the red light corresponds to the first light.

### SUMMARY OF PRESENT DISCLOSURE

The present disclosure will be summarized below as additional remarks.

(Additional Remark 1) An optical element including: a substrate configured to transmit first light having a first wavelength band and second light having a second wavelength band different from the first wavelength band; and a first optical layer disposed in a first region in a plane parallel to a first surface of the substrate that is a surface on which the first light and the second light are incident, in which a refractive index and a thickness of the first optical layer are so set that the first light incident on the first region passes through the first region, that a phase difference between the first light having a centrobaric wavelength in the first wavelength band and passing through the first region and the first light having the centrobaric wavelength and passing through a second region other than the first region in the plane parallel to the first surface is greater than or equal to −90° but smaller than or equal to 90°, and that the second light incident on the first region is blocked.

The configuration described in Additional Remark 1, in which the phase difference between the first light passing through the first region and the second light passing through the second region is greater than or equal to −90° but smaller than or equal to 90°, can suppress the situation in which the two types of first light scattered or diffracted at the circumferential edge of the first optical layer weaken each other, can suppress occurrence of illuminance unevenness of the first light, and prevent the first light that does not originally generate patterned light from generating patterned light. Furthermore, according to the configuration described in Additional Remark 1, since the second light incident on the first region is blocked by the first optical layer, the patterned light derived from the infrared light IL can be favorably generated.

(Additional Remark 2) An optical element including: a substrate configured to transmit first light having a first wavelength band and second light having a second wavelength band different from the first wavelength band; and a first optical layer disposed in a first region in a plane parallel to a first surface of the substrate that is a surface on which the first light and the second light are incident, in which a refractive index and a thickness of the first optical layer are so set that the first light incident on the first region passes through the first region, that an optical path between the first light having a centrobaric wavelength in the first wavelength band and passing through the first region and the first light having the centrobaric wavelength and passing through a second region other than the first region in the plane parallel to the first surface is a natural number multiple of a reference wavelength of the first light, and that the second light incident on the first region is blocked.

The configuration described in Additional Remark 2, in which the phase difference between the first light passing through the first region and the second light passing through the second region is a natural number multiple of the reference wavelength of the first light, can suppress the situation in which the two types of first light scattered or diffracted at the circumferential edge of the first optical layer weaken each other, can suppress occurrence of illuminance unevenness of the first light, and prevent the first light that does not originally generate patterned light from generating patterned light. Furthermore, according to the configuration described in Additional Remark 2, since the second light incident on the first region is blocked by the first optical layer, the patterned light derived from the infrared light IL can be favorably generated.

(Additional Remark 3) The optical element according to Additional Remark 1 or 2, in which a second surface of the first optical layer that is a surface on which the first light and the second light are incident is exposed.

According to the configuration of Additional Remark 3, the optical element can be readily produced at low cost by using a production method based on a lift-off or etching technology.

(Additional Remark 4) The optical element according to any of Additional Remarks 1 to 3, further including a second optical layer disposed at the first surface in the first region and the second region, in which the first optical layer is formed at a third surface of the second optical layer in the first region that is a surface on which the first light and the second light are incident.

According to the configuration of Additional Remark 4, the optical element can be readily produced at low cost by performing patterning once.

(Additional Remark 5) The optical element according to Additional Remark 4, in which the third surface in the first region is exposed.

According to the configuration of Additional Remark 5, the optical element can be readily produced at low cost by performing patterning once and a small number of steps.

(Additional Remark 6) The optical element according to any of Additional Remarks 1 to 5, in which the first optical layer is configured with a dielectric multilayer film including a high refractive index layer and a low refractive index layer having a refractive index lower than a refractive index of the high refractive index layer.

According to the configuration of Additional Remark 6, the refractive index and the thickness of the low refractive index layer and the refractive index and the thickness of the high refractive index layer can be flexibly adjusted and the effective refractive index and thickness of the first optical layer can be appropriately set in a way that the phase difference between the first light passing through the first region and the second light passing through the second region is greater than or equal to −90° but smaller than or equal to 90°, or the optical path length difference between the first light passing through the first region and the second light passing through the second region is a natural number multiple of a reference wavelength of the first light. The configuration of Additional Remark 6 allows a widened range from which the material of each of the low refractive index layer and the high refractive index layer is selected.

(Additional Remark 7) The optical element according to any of Additional Remarks 1 to 6, in which at least a portion of the first wavelength band falls within a visible wavelength band, and the second wavelength band falls within a wavelength band longer than the visible wavelength band or a wavelength band shorter than the visible wavelength band.

According to the configuration of Additional Remark 7, a user of the optical element can visually recognize and utilize the first light emitted from the optical element as visible light containing no pattern. The user of the optical element can capture an image of the second light emitted from the optical element with an imaging apparatus having sensitivity to light having the wavelength band longer than the visible wavelength band or the wavelength band shorter than the visible wavelength band as invisible light containing a pattern, and can adjust an optical system including the optical element in accordance with clarity or any other factor of the pattern.

(Additional Remark 8) The optical element according to Additional Remark 7, in which the second light is infrared light.

The configuration of Additional Remark 8, in which the energy of the infrared light is relatively lower than the energy of the visible light containing the first light, can reduce deterioration of the imaging apparatus that captures an image of the infrared light, which is the second light, or a detector that detects the infrared light.

(Additional Remark 9) The optical element according to any of Additional Remarks 1 to 8, in which the phase difference is greater than or equal to −60° but smaller than or equal to 60°.

In the configuration of Additional Remark 9, the phase difference between the first light passing through the first region and the first light passing through the second region is preferably set to be greater than or equal to −90° but smaller than or equal to 90°. The configuration of Additional Remark 9 can further suppress the situation in which the two types of first light scattered or diffracted at the circumferential edge of the first optical layer weaken each other, can further suppress occurrence of illuminance unevenness of the first light emitted from the optical element, and suppress generation of patterned light according to the arrangement and shape of the first optical layer as much as possible.

(Additional Remark 10) The optical element according to Additional Remark 1 or 2, further including a medium disposed at a second surface of the first optical layer that is a surface on which the first light and the second light are incident and at the first surface in the second region, in which a refractive index of the medium is greater than 1.0, a fifth surface of the medium that is a surface opposite a fourth surface on which the first light and the second light are incident is in contact with the second surface of the first optical layer, which is the surface on which the first light and the second light are incident, in the first region, the fifth surface is in contact with the first surface in the second region, and a thickness of the medium in the second region differs from a thickness of the medium in the first region.

According to the configuration of Additional Remark 10, the medium in the second region can be made thicker than the first optical layer in the first region in consideration of the thickness of the first optical layer to suppress the difference in physical thickness between the first region and the second region, and ensure the planarity of the optical element in the entire first and second regions, so that the optical element can be readily handled.

(Additional Remark 11) The optical element according to Additional Remark 10, in which the refractive index of the medium is comparable to a refractive index of the substrate.

The configuration of Additional Remark 11 can suppress reflection of the first light off the first surface of the substrate in the second region, suppress occurrence of beam deviation due to an error in the production of the optical element, and suppress the amount of the beam deviation.

(Additional Remark 12) The optical element according to Additional Remark 10 or 11, in which the fourth surface of the medium in the first region, which is the surface on which the first light and the second light are incident, and the fourth surface in the second region form a single planar surface.

The configuration of Additional Remark 12, in which a surface of the medium of the optical element that is the surface on which the first light and the second light are incident is a planar surface in the first region and the second region, and a plate surface of the substrate of the optical element that is the surface via which the first light and the second light exit is a planar surface in the first region and the second region, can increase the planarity of the entire optical element, so that the optical element can be readily disposed or supported in the optical system.

(Additional Remark 13) The optical element according to Additional Remark 10, in which the refractive index of the medium differs from a refractive index of the substrate, and the optical element includes an antireflection film disposed between the substrate and the first optical layer in the first region and between the substrate and the medium in the second region.

According to the configuration of Additional Remark 13, for example, even when the medium has a refractive index higher than the refractive index of the substrate, the reflection of the first light off the first surface of the substrate can be suppressed by the antireflection film. An inexpensive substrate can therefore be used irrespective of the material of the medium.

(Additional Remark 14) The optical element according to Additional Remark 11, in which the first optical layer is configured with a dielectric multilayer film including a high refractive index layer and a low refractive index layer having a refractive index lower than a refractive index of the high refractive index layer, and the refractive index of the medium is comparable to the refractive index of the low refractive index layer.

The configuration of Additional Remark 14 allows a widened range from which the material of the medium is selected, so that the optical element can be readily manufactured. According to the configuration of Additional Remark 14, the optical path length of the first light in the second region is prolonged, so that suppressing illuminance unevenness of the first light emitted from the optical element and blocking the second light in the second region can both be readily achieved as compared, for example, with the optical element according to Additional Remark 3.

(Additional Remark 15) The optical element according to Additional Remark 11, in which the first optical layer is configured with a dielectric multilayer film including a high refractive index layer and a low refractive index layer having a refractive index lower than a refractive index of the high refractive index layer, and the refractive index of the medium is higher than the refractive index of the low refractive index layer but lower than the refractive index of the high refractive index layer.

The configuration of Additional Remark 15 allows a widened range from which the material of the medium is selected, so that the optical element can be readily manufactured. The configuration of Additional Remark 15 can readily bring the phase difference between the first light passing through the first region and the first light passing through the second region close to 0°, can suppress the situation in which the two types of first light scattered or diffracted at the circumferential edge of the first optical layer weaken each other, and can suppress occurrence of illuminance unevenness of the first light as compared, for example, with the optical element according to Additional Remark 14.

(Additional Remark 16) The optical element according to Additional Remark 11, in which the first optical layer is configured with a dielectric multilayer film including a high refractive index layer and a low refractive index layer having a refractive index lower than a refractive index of the high refractive index layer, and the refractive index of the medium is comparable to the refractive index of the high refractive index layer.

According to the configuration of Additional Remark 16, the optical path length of the first light in the second region is prolonged, so that suppressing illuminance unevenness of the first light emitted from the optical element and blocking the second light in the second region can both be readily achieved as compared, for example, with the optical element according to Additional Remark 3.

(Additional Remark 17) An optical instrument including the optical element according to any of Additional Remarks 1 to 16.

The configuration of Additional Remark 17 can suppress generation of a pattern in the first light displayed at a position downstream of the optical element in the optical instrument, utilize the first light in accordance with desired information, form patterned light containing a pattern derived from the second light, and adjust the arrangement of an entire optical system of the optical instrument, the conditions under which the entire optical system operates, and other factors thereof with high accuracy.

What is claimed is:

1. An optical element comprising:
a substrate configured to transmit first light having a first wavelength band and second light having a second wavelength band different from the first wavelength band; and
a first optical layer disposed in a first region in a plane parallel to a first surface of the substrate that is a surface on which the first light and the second light are incident,
wherein a refractive index and a thickness of the first optical layer are so set that the first light incident on the first region passes through the first region, that a phase difference between the first light having a centrobaric wavelength in the first wavelength band and passing through the first region and the first light having the centrobaric wavelength and passing through a second region other than the first region in the plane parallel to the first surface is greater than or equal to −90° but smaller than or equal to 90°, and that the second light incident on the first region is blocked.

2. An optical element comprising:
a substrate configured to transmit first light having a first wavelength band and second light having a second wavelength band different from the first wavelength band; and
a first optical layer disposed in a first region in a plane parallel to a first surface of the substrate that is a surface on which the first light and the second light are incident,
wherein a refractive index and a thickness of the first optical layer are so set that the first light incident on the first region passes through the first region, that an optical path between the first light having a centrobaric wavelength in the first wavelength band and passing through the first region and the first light having the centrobaric wavelength and passing through a second region other than the first region in the plane parallel to the first surface is a natural number multiple of a reference wavelength of the first light, and that the second light incident on the first region is blocked.

3. The optical element according to claim 1, wherein
a second surface of the first optical layer that is a surface on which the first light and the second light are incident is exposed.

4. The optical element according to claim 1, further comprising
a second optical layer disposed at the first surface in the first region and the second region,
wherein the first optical layer is formed at a third surface of the second optical layer in the first region that is a surface on which the first light and the second light are incident.

5. The optical element according to claim 4, wherein
the third surface in the first region is exposed.

6. The optical element according to claim 3, wherein
the first optical layer is configured with a dielectric multilayer film including a high refractive index layer and a low refractive index layer having a refractive index lower than a refractive index of the high refractive index layer.

7. The optical element according to claim 1, wherein
at least a portion of the first wavelength band falls within a visible wavelength band, and
the second wavelength band falls within a wavelength band longer than the visible wavelength band or a wavelength band shorter than the visible wavelength band.

8. The optical element according to claim 6, wherein
the second light is infrared light.

9. The optical element according to claim 1, wherein
the phase difference is greater than or equal to −60° but smaller than or equal to 60°.

10. The optical element according to claim 1, further comprising
a medium disposed at a second surface of the first optical layer that is a surface on which the first light and the second light are incident and at the first surface in the second region,
wherein a refractive index of the medium is greater than 1.0,
a fifth surface of the medium that is a surface opposite a fourth surface on which the first light and the second light are incident is in contact with the second surface of the first optical layer, which is the surface on which the first light and the second light are incident, in the first region,
the fifth surface is in contact with the first surface in the second region, and
a thickness of the medium in the second region differs from a thickness of the medium in the first region.

11. The optical element according to claim 10, wherein
the refractive index of the medium is comparable to a refractive index of the substrate.

12. The optical element according to claim 10, wherein
the fourth surface of the medium in the first region, which is the surface on which the first light and the second light are incident, and the fourth surface in the second region form a single planar surface.

13. The optical element according to claim 10, wherein
the refractive index of the medium differs from a refractive index of the substrate, and
the optical element comprises an antireflection film disposed between the substrate and the first optical layer in the first region and between the substrate and the medium in the second region.

14. The optical element according to claim 11, wherein
the first optical layer is configured with a dielectric multilayer film including a high refractive index layer and a low refractive index layer having a refractive index lower than a refractive index of the high refractive index layer, and
the refractive index of the medium is comparable to the refractive index of the low refractive index layer.

15. The optical element according to claim 11, wherein
the first optical layer is configured with a dielectric multilayer film including a high refractive index layer and a low refractive index layer having a refractive index lower than a refractive index of the high refractive index layer, and
the refractive index of the medium is higher than the refractive index of the low refractive index layer but lower than the refractive index of the high refractive index layer.

16. The optical element according to claim 11, wherein
the first optical layer is configured with a dielectric multilayer film including a high refractive index layer and a low refractive index layer having a refractive index lower than a refractive index of the high refractive index layer, and
the refractive index of the medium is comparable to the refractive index of the high refractive index layer.

17. An optical instrument comprising
the optical element according to claim 1.
